(19) United States
(12) Patent Application Publication
(10) Pub. No.: US 2022/0003038 A1
(43) Pub. Date: Jan. 6, 2022

(54) DIMMING SUBSTRATE, DIMMING GLASS AND APPARATUS, AND LIGHT TRANSMITTANCE ADJUSTING SYSTEM

(71) Applicants: Beijing BOE Sensor Technology Co., Ltd., Beijing (CN); BOE TECHNOLOGY GROUP CO., LTD., Beijing (CN)

(72) Inventors: Juan CHEN, Beijing (CN); Jing YU, Beijing (CN); Sikai ZHANG, Beijing (CN); Chunlei WANG, Beijing (CN)

(21) Appl. No.: 17/356,904

(22) Filed: Jun. 24, 2021

(30) Foreign Application Priority Data
Jul. 1, 2020 (CN) 202010623934.6

(51) Int. Cl. E06B 9/24; G02F 1/1516; G02F 1/155; G02F 1/163

(52) U.S. Cl. CPC E06B 9/24; G02F 1/15165; E06B 2009/2464; G02F 1/163; G02F 1/155

(57) ABSTRACT

A dimming substrate includes an infrared light dimming structure. The infrared light dimming structure includes a first electrode layer, a second electrode layer, and an electro-dimming layer. The second electrode layer is disposed opposite to the first electrode layer. The electro-dimming layer is disposed between the first electrode layer and the second electrode layer, and is configured such that a reflectivity of the electro-dimming layer to infrared light is changeable in response to a first potential difference applied between the first electrode layer and the second electrode layer.

### CROSS-REFERENCE TO RELATED APPLICATION

This application claims priority to Chinese Patent Application No. 202010623934.6, filed on Jul. 1 2020, which is incorporated herein by reference in its entirety.

### TECHNICAL HELD

The present disclosure relates to the field of display technologies and the technical field of dimming glass, and in particular, to a dimming substrate, a dimming glass and an apparatus, and a light transmittance adjusting system.

### BACKGROUND

Dimming glass (also referred to as smart glass) is a novel photoelectric glass product with a sandwich structure. Generally, a transmittance (or a reflectivity) of the dimming glass to light may be changed by adjusting a potential difference between two opposite sides of an electrochromic layer in the dimming glass, so that the dimming glass can be switched among light transmission states to different degrees, and a purpose of dimming may be achieved. Based on this, the dimming glass is widely used in various fields such as indoor glass doors and windows, exterior walls of buildings, and vehicles.

### SUMMARY

In an aspect, a dimming substrate is provided. The dimming substrate includes an infrared light dimming structure. The infrared light dimming structure includes a first electrode layer, a second electrode layer, and an electro-dimming layer. The second electrode layer is disposed opposite to the first electrode layer. The electro-dimming layer is disposed between the first electrode layer and the second electrode layer, and is configured such that it's a reflectivity of the electro-dimming layer to infrared light is changeable in response to a first potential difference applied between the first electrode layer and the second electrode layer.

In some embodiments, a material of the electro-dimming layer includes a polymer, and a monomer of the polymer is 3,4-(2,2-dimethyl-propylenedioxy) thiophene.

In some embodiments, the infrared light dimming structure further includes a first ion transport layer and a first ion storage layer. The first ion transport layer is disposed between the first electrode layer and the second electrode layer, and is stacked with the electro-dimming layer. The first ion storage layer is disposed between the first electrode layer and the second electrode layer, and is stacked with the first ion transport layer, and the first ion storage layer is in direct contact with at least the first ion transport layer.

In some embodiments, the first electrode layer or the second electrode layer includes a plurality of first electrode patterns arranged at intervals. The electro-dimming layer includes a plurality of electro-dimming patterns arranged at intervals, and an orthogonal projection of each electro-dimming pattern on a first plane perpendicular to a thickness direction of the infrared light dimming structure and an orthogonal projection of a respective one of the plurality of first electrode patterns on the first plane have an overlapping region there between. The infrared light dimming structure further includes a plurality of first barrier walls arranged at intervals and disposed between the first electrode layer and the second electrode layer. A respective first barrier wall of the plurality of first barrier walls is provided between any two adjacent first electrode patterns, and the first barrier wall is located between two electro-dimming patterns corresponding to the two adjacent first electrode patterns.

In some embodiments, a transmittance of the electro-dimming layer to visible light is greater than 40%. The dimming substrate further includes a visible light dimming structure stacked with the infrared light dimming structure, and the visible light dimming structure is configured to be reversibly switchable between at least a first transparent state and a first color rendering state.

In some embodiments, the visible light dimming structure includes a third electrode layer, a fourth electrode layer and a first electrochromic layer. The fourth electrode layer is disposed opposite to the third electrode layer. The first electrochromic layer is disposed between the third electrode layer and the fourth electrode layer, and is configured to be reversibly switchable between the first transparent state and the first color rendering state in response to a second potential difference applied between the third electrode layer and the fourth electrode.

In some embodiments, the third electrode layer or the fourth electrode layer includes a plurality of second electrode patterns arranged at intervals. The first electrochromic layer includes a plurality of first electrochromic patterns arranged at intervals, and an orthogonal projection of each first electrochromic pattern on a second plane perpendicular to a thickness direction of the visible light dimming structure and an orthogonal projection of a respective one of the plurality of second electrode patterns on the second plane have an overlapping region therebetween. The visible light dimming structure further includes a plurality of second barrier walls arranged at intervals and disposed between the third electrode layer and the fourth electrode layer. A respective second barrier wall of the plurality of second barrier walls is provided between any two adjacent second electrode patterns, and the second barrier wall is located between two first electrochromic patterns corresponding to the two adjacent second electrode patterns.

In some embodiments, the visible light dimming structure further includes a second electrochromic layer. The second electrochromic layer is disposed between the third electrode layer and the fourth electrode layer, and is configured to be reversibly switchable between a second transparent state and a second color rendering state in response to the second potential difference.

In some embodiments, the third electrode layer or the fourth electrode layer includes a plurality of second electrode patterns arranged at intervals. The second electrochromic layer includes a plurality of second electrochromic patterns arranged at intervals, and an orthogonal projection of each second electrochromic pattern on a second plane perpendicular to a thickness direction of the visible light dimming structure and an orthogonal projection of a respective one of the plurality of second electrode patterns on the second plane have an overlapping region therebetween.

In some embodiments, the visible light dimming structure further includes a second ion transport layer and a second ion storage layer. The second ion transport layer is disposed between the third electrode layer and the fourth electrode layer, and is stacked with the first electrochromic layer, The second ion storage layer is disposed between the third electrode layer and the fourth electrode layer, and is stacked with the second ion transport layer.

In another aspect, a dimming glass is provided. The dimming glass includes a first transparent sheet and the dimming substrate according to any one of the above embodiments. The dimming substrate and the first transparent sheet are stacked.

In some embodiments, the dimming substrate further includes a visible light dimming structure stacked with the infrared light dimming structure, and the visible light dimming structure is configured to be reversibly switchable between at least a first transparent state and a first color rendering state.

In some embodiments, the dimming glass further includes a second transparent sheet. The dimming substrate is located between the first transparent sheet and the second transparent sheet.

In yet another aspect, an apparatus with a viewing window is provided. The apparatus with the viewing window includes a viewing window frame and the dimming glass according to any one of the above embodiments. The dimming glass is installed in the viewing window frame to form the viewing window.

In yet another aspect, a light transmittance adjusting system is provided. The light transmittance adjusting system includes a first voltage supply device and the dimming substrate according to any one of the above embodiments. The first voltage supply device is electrically connected to the first electrode layer and the second electrode layer, and is configured to apply the first potential difference between the first electrode layer and the second electrode layer.

In some embodiments, the first voltage supply device is configured to apply the first potential difference in a range of −1.5 V to 0 V inclusive between the first electrode layer and the second electrode layer.

In some embodiments, the dimming substrate further includes a visible light dimming structure, and the visible light dimming structure includes a third electrode layer, a first electrochromic layer and a fourth electrode layer that are stacked. The first electrochromic layer is configured to be reversibly switchable between a first transparent state and a first color rendering state in response to a second potential difference applied between the third electrode layer and the fourth electrode. The light transmittance adjusting system further includes a second voltage supply device. The second voltage supply device is electrically connected to the third electrode layer and the fourth electrode layer, and is configured to apply the second potential difference between the third electrode layer and the fourth electrode layer.

In some embodiments, the second voltage supply device is configured to apply the second potential difference in a range of 2 V to 4 V inclusive between the third electrode layer and the fourth electrode layer.

### BRIEF DESCRIPTION OF THE DRAWINGS

In order to describe technical solutions in the present disclosure more clearly, accompanying drawings to be used in some embodiments of the present disclosure will be introduced briefly below. However, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, and are not limitations on actual sizes of products, and actual processes of methods to which the embodiments of the present disclosure relate.

FIG. 1 is a schematic diagram illustrating a structure of an apparatus with a viewing window in accordance with some embodiments;

FIG. 2A is a schematic diagram illustrating a structure of a dimming glass in accordance with some embodiments;

FIG. 2B is a schematic diagram illustrating a structure of another dimming glass in accordance with some embodiments;

FIG. 3A is a schematic diagram illustrating a structure of yet another dimming glass in accordance with some embodiments;

FIG. 3B is a schematic diagram illustrating a structure of yet another dimming glass in accordance with some embodiments;

FIG. 3C is a schematic diagram illustrating a structure of yet another dimming glass in accordance with some embodiments;

FIG. 4A is a schematic diagram illustrating a structure of a dimming substrate in accordance with some embodiments;

FIG. 4B is a schematic diagram illustrating a structure of another dimming substrate in accordance with some embodiments;

FIG. 4C is a schematic diagram illustrating a structure of yet another dimming substrate in accordance with some embodiments;

FIG. 5 is a spectrogram of reflectivities of an infrared light dimming structure to light in response to different first potential differences in accordance with some embodiments;

FIG. 6 is an exploded schematic diagram of an infrared light dimming structure in accordance with some embodiments;

FIG. 7 is a sectional diagram of the infrared light dimming structure taken along the line A-A′ in FIG. 6;

FIG. 8 is a schematic diagram illustrating a structure of yet another dimming substrate in accordance with some embodiments;

FIG. 9A is a schematic diagram illustrating a structure of yet another dimming glass in accordance with some embodiments;

FIG. 9B is a schematic diagram illustrating a structure of yet another dimming glass in accordance with some embodiments;

FIG. 9C is a schematic diagram illustrating a structure of yet another dimming glass in accordance with some embodiments;

FIG. 10A is a schematic diagram illustrating a structure of yet another dimming glass in accordance with some embodiments;

FIG. 10B is a schematic diagram illustrating a structure of yet another dimming glass in accordance with some embodiments;

FIG. 11A is an exploded schematic diagram of a visible light dimming structure in accordance with some embodiments;

FIG. 11B is an exploded schematic diagram of another visible light dimming structure in accordance with some embodiments;

FIG. 11C is a schematic diagram illustrating an electrical connection between each second electrode pattern in a visible light dimming structure and a corresponding electrode line in accordance with some embodiments;

FIG. 12 is a sectional diagram of the visible light dimming structure taken along the line B-B′ in FIG. 11A;

FIG. 13 is an exploded schematic diagram of yet another visible light dimming structure in accordance with some embodiments;

FIG. 14A is a sectional diagram of the visible light dimming structure taken along the line C-C′ in FIG. 13;

FIG. 14B is another sectional diagram of the visible light dimming structure taken along the line C-C′ in FIG. 13;

FIG. 15 is a schematic diagram illustrating a structure of yet another dimming glass in accordance with some embodiments;

FIG. 16 is a schematic diagram illustrating a structure of yet another dimming glass in accordance with some embodiments;

FIG. 17 is a schematic diagram illustrating a structure of yet another dimming substrate in accordance with some embodiments;

FIG. 18 is a schematic diagram illustrating a structure of a light transmittance adjusting system in accordance with some embodiments;

FIG. 19 is a schematic diagram illustrating an electrical connection between an infrared light dimming structure and flexible circuit boards in accordance with some embodiments;

FIG. 20 is a schematic diagram illustrating an electrical connection between an infrared light dimming structure and a first voltage supply device in accordance with some embodiments; and

FIG. 21 is a schematic diagram illustrating an application scenario of a dimming glass in accordance with some embodiments.

### DETAILED DESCRIPTION

Technical solutions in some embodiments of the present disclosure will be described clearly and completely with reference to the accompanying drawings below. However, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive, i.e., “including, but not limited to.” In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, features defined as “first” and “second” may explicitly or implicitly include one or more of the features. As used in this description and the appended claims, the singular forms “a/an” and “the” may also include plural referents unless the content dearly dictates otherwise. In the description of the embodiments of the present disclosure, the term “a plurality of” means two or more unless otherwise specified.

In the description of some embodiments, the terms “coupled” and “connected” and their extensions may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

As used herein, the term “if”, depending on the context, is optionally construed as “when” or “in a case where” or “in response to determining” or “in response to detecting”. Similarly, the phrase “if it is determined” or “if [a stated condition or event] is detected”, depending on the context, is optionally construed as “in a case where it is determined” or “in response to determining” or “in a case where [the stated condition or event] is detected” or “in response to detecting [the stated condition or event]”.

The use of the phrase “applicable to” or “configured to” herein means an open and inclusive language, which does not exclude devices that are applicable to or configured to perform additional tasks or steps.

In addition, the use of the phrase “based on” is meant to be open and inclusive, since a process, step, calculation or other action that is “based on” one or more of the stated conditions or values may, in practice, be based on additional conditions or values exceeding those stated.

The term “about” or “approximately” as used herein is inclusive of a stated value and an average value within an acceptable range of deviation of a particular value. The acceptable range of deviation is determined by a person of ordinary skill in the art in view of measurement in question and errors associated with measurement of a particular quantity (i.e., limitations of a measurement system).

Exemplary embodiments are described herein with reference to sectional views and/or plan views as idealized exemplary drawings. In the accompanying drawings, thicknesses of layers and regions are enlarged for clarity. The exemplary embodiments of the present disclosure should not be construed to be limited to shapes of the regions shown herein, but to include deviations in shape due to, for example, manufacturing. For example, an etched region shown in a rectangular shape generally has a curved feature. Therefore, the regions shown in the accompanying drawings are schematic in nature, and their shapes are not intended to show actual shapes of the regions in a device, and are not intended to limit the scope of the exemplary embodiments.

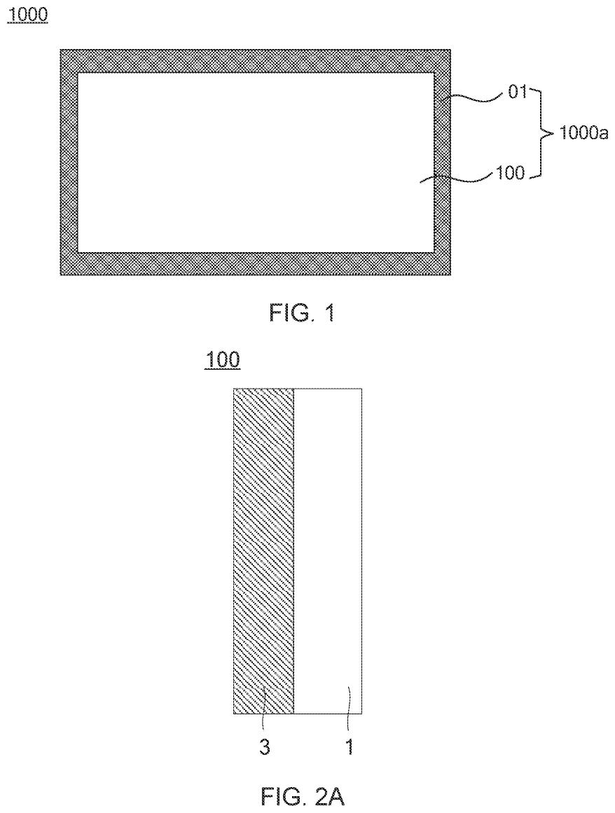

Some embodiments of the present disclosure provide an apparatus with a viewing window. As shown in FIG. 1, the apparatus 1000 with the viewing window 1000a includes a viewing window frame 01 and a dimming glass 100. The dimming glass 100 is installed in the viewing window frame 01 to form the viewing window 1000a. The dimming glass 100 is capable of changing a transmittance and/or a reflectivity of light incident on its surface, so as to achieve a purpose of dimming.

Herein, the apparatus 1000 with the viewing window 1000a may include one or more viewing window frames 01 each provided with a respective dimming glass 100 therein. Moreover, the apparatus 1000 with the viewing window 1000a may be any apparatus with a viewing function, such as a wearable device (e.g., a helmet or eyeglasses), a piece of furniture (e.g., a cabinet or a bookcase), a home appliance (e.g., a freezer or a washing machine), a vehicle (e.g., an automobile, a train, an airplane, or a steamship), or an indoor/outdoor building, which is not limited in the embodiments of the present disclosure.

Based on this, in a case where the dimming glass 100 is installed in the viewing window frame 01 to form the viewing window 1000a in the apparatus 1000, the viewing window frame 01 may be, for example, a helmet frame, an eyeglass frame, a window frame, or a door frame.

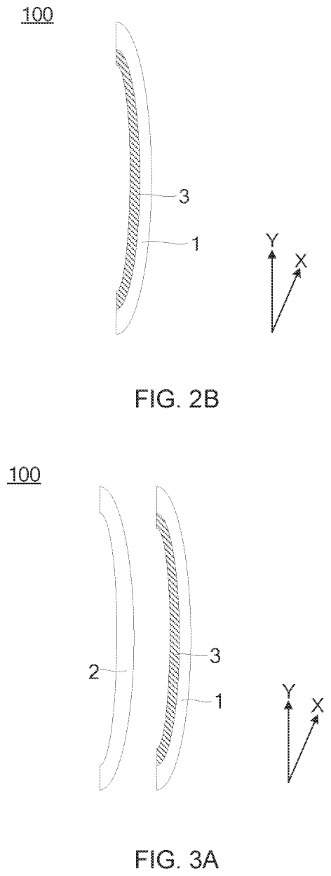

Some embodiments of the present disclosure provide a dimming glass 100, which may be applied to the apparatus 1000 with the viewing window 1000a. As shown in FIGS. 2A and 2B, the dimming glass 100 includes a first transparent sheet 1 and a dimming substrate 3 that are stacked.

In some embodiments, as shown in FIGS, 3A to 30, the dimming glass 100 further includes a second transparent sheet 2, and the dimming substrate 3 is located between the first transparent sheet 1 and the second transparent sheet 2.

In the embodiments of the present disclosure, the first transparent sheet 1 and the second transparent sheet 2 may be rigid or flexible, which is not limited in the embodiments of the present disclosure. In a case where the two transparent sheets are both flexible, the dimming substrate 3 is also flexible. In this way, the dimming glass 100 may be bent to adapt to different application scenarios.

In some examples, in a case where the first transparent sheet 1 and the second transparent sheet 2 are rigid, materials of the first transparent sheet 1 and the second transparent sheet 2 each include at least one of glass and quartz.

In some other examples, in the case where the first transparent sheet 1 and the second transparent sheet 2 are flexible, the materials of the first transparent sheet 1 and the second transparent sheet 2 may each be an organic material, such as at least one of polyethylene glycol terephthalate (PET), triacetyl cellulose (TAO), cyclo olefin polymer (COP) and polyimide (PI). Of course, the materials of the first transparent sheet 1 and the second transparent sheet 2 may also each be an inorganic material. For example, the first transparent sheet 1 and the second transparent sheet 2 may each be ultra-thin glass including silicon dioxide and other oxides. Herein, the ultra-thin glass refers to glass with a small thickness, for example, of 0.1 to 1.1 mm. In this way, the ultra-thin glass may have a curved shape due to its small thickness.

FIGS, 2B and 3A show examples in which the first transparent sheet 1 and the second transparent sheet 2 are flexible, and FIGS. 2A, 33 and 30 show examples in which the first transparent sheet 1 and the second transparent sheet 2 are rigid.

In some embodiments, as shown in FIG. 30, a space between the dimming substrate 3 and the second transparent sheet 2 is filled with a dry gas (e.g., inert gas), in which case the dimming glass 100 may also be referred to as hollow glass. Herein, in the hollow glass, the first transparent sheet 1 and the second transparent sheet 2 (e.g., glass sheets) may be separated by a spacer material, and be sealed together by means of a sealing material, so that a space filled with the dry gas is formed between the two glass sheets. By using the dry gas with which the space between the two glass sheets is filled, the hollow glass may have good heat preservation and sound insulation properties, and may be applicable to various occasions.

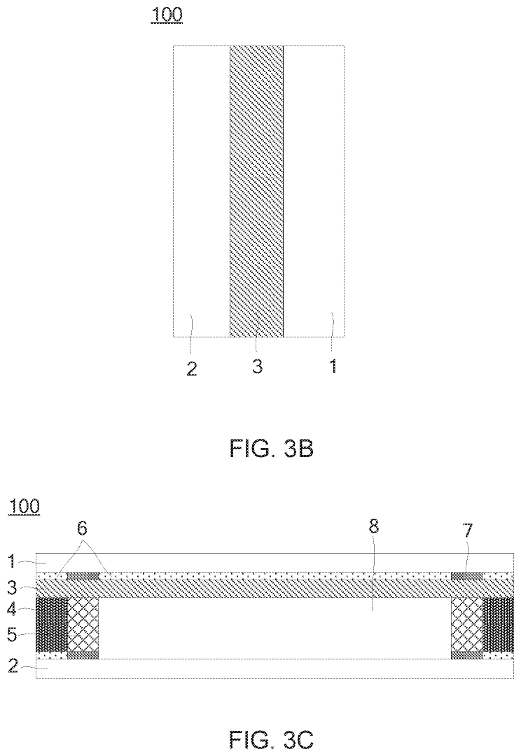

In some examples, as shown in FIG. 3C, the dimming glass 100 further includes a sealant 4 (i.e., the above sealing material), a support ring frame 5 the above spacer material), a transparent adhesive 6, a frame sealant 7 (e.g., a black frame sealant), and a gas filling cavity 8. Herein, for example, the sealant 4 may be a black sealant, the frame sealant 7 may be a black frame sealant, and the support ring frame 5 may be made of stainless steel.

The stainless steel support ring frame 5 is disposed between the dimming substrate 3 and the second transparent sheet 2, and is configured to separate the dimming substrate 3 and the second transparent sheet 2, so that the gas filling cavity 8 is formed between the dimming substrate 3 and the second transparent sheet 2. The gas filling cavity 8 is configured to be filled with the dry gas, such as a dry inert gas. The transparent adhesive 6 and the black frame sealant 7 are configured to adhere and fix the first transparent sheet 1 and the dimming substrate 3, and to adhere and fix the second transparent sheet 2 and the stainless steel support ring frame 5, so as to form the gas filling cavity 8. The black sealant 4 is configured to seal peripheral edges of the hollow glass.

The inert gas may also be referred to as a noble gas, which is a gas corresponding to an element in Group 0 (18) in the periodic table. They are both colorless and odorless monatomic gases at normal temperature and pressure, and are difficult to react chemically. Noble gases include helium (He), neon (Ne), argon (Ar), krypton (Kr), and xenon (Xe). The gas filling cavity 8 may be filled with at least one of He, Ne, Ar, Kr, and Xe. Of course, the gas filling cavity 8 may also be filled with any other dry gas that is not an inert gas, such as nitrogen (N₂), which is not limited in the embodiments of the present disclosure, as long as the gas with which the gas filling cavity 8 is filled may keep the space between the dimming substrate 3 and the second transparent sheet 2 dry. The dry gas may ensure that no condensation is generated inside the hollow glass, so that a service life of the hollow glass may be prolonged.

In some embodiments, as shown in FIG. 30, in a case where the dimming glass 100 is the hollow glass, a surface of the dimming substrate 3 facing away from the second transparent sheet 2 is connected to the first transparent sheet 1 through the transparent adhesive 6.

In a dimming glass, a low-emissivity (Low-E) film is coated on a dimming substrate in the dimming glass, and the Low-E film may achieve a filtering effect on infrared light. The infrared light is one of various invisible light in sunlight, which is also referred to as infrared thermal radiation, and has a strong thermal effect. The Low-E film is a film-based product composed of multiple layers of metals or other compounds, which has a high transmittance to visible light and a high reflectivity to the infrared light; thus, it has a good heat insulation property. However, the filtering effect (i.e., the reflectivity) of the Low-E film on the infrared light is constant and cannot be adjusted, which causes that a heat insulation effect of the dimming glass in any environment is the same, and different requirements cannot be met. For example, the dimming glass coated with the Low-E film filters the infrared light in summer and also filters the infrared light in winter, which causes that the dimming glass cannot achieve an effect of adjusting an indoor temperature according to an outdoor temperature when applied to, for example, a building.

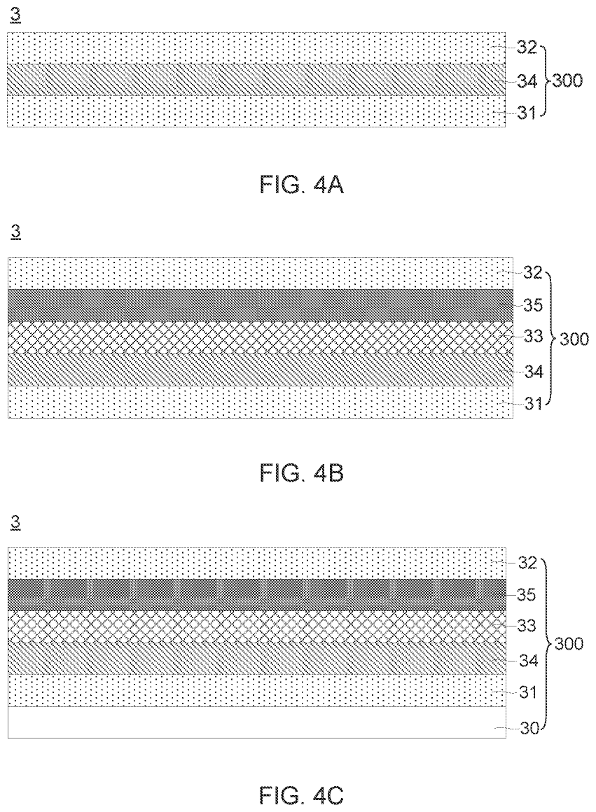

Based on this, some embodiments of the present disclosure provide a dimming substrate, which may be applied to the dimming glass 100. As shown in FIG. 4A, the dimming substrate 3 includes an infrared light dimming structure 300. The infrared light dimming structure 300 includes a first electrode layer 31, a second electrode layer 32, and an electro-dimming layer 34 that are stacked.

As shown in FIG. 4A, the first electrode layer 31 and the second electrode layer 32 are disposed opposite to each other. The electro-dimming layer 34 is disposed between the first electrode layer 31 and the second electrode layer 32, and is configured to change its reflectivity to the infrared light in response to a first potential difference applied between the first electrode layer 31 and the second electrode layer 32. That is, the reflectivity of the electro-dimming layer 34 to the infrared light is changeable in response to the first potential difference.

For example, the first electrode layer 31 and the second electrode layer 32 are both transparent electrode layers. Herein, the term “transparent electrode layers” means that the electrode layers have high transmittances to light (including at least the infrared light) to reduce influences of the first electrode layer 31 and the second electrode layer 32 on the transmittances to the infrared light. Herein, materials of the transparent electrode layers may each be, for example, indium tin oxide (ITO), fluorine-doped tin oxide (FTG) or zinc aluminum oxide (ZAO), or a material with a transparent conductive property such as a carbon nanotube polymer composite material, or a conductive material formed by adding any one or more of metals or non-metals such as copper (Cu), silver (Ag), gold (Au) and carbon (C) to any one of the above materials, such as a nano-carbon conductive material or a nano-silver conductive material. In addition, the materials of the first electrode layer 31 and the second electrode layer 32 may be the same or different, which is not limited in the embodiments of the present disclosure.

In the embodiments of the present disclosure, after the first potential difference is applied between the first electrode layer 31 and the second electrode layer 32, electrons are transported between the first electrode layer 31 and the second electrode layer 32, and a material of the electro-dimming layer 34 undergoes a color change reaction (e.g., an oxidation-reduction reaction) during the transport of the electrons, and a product generated after the color change reaction is capable of reflecting the infrared light. In addition, in a case where different first potential differences are applied between the first electrode layer 31 and the second electrode layer 32, products generated after the color change reaction of the material of the electro-dimming layer 34 are different, so that reflectivities of the electro-dimming layer 34 to the infrared light are different. That is, by changing the first potential difference applied between the first electrode layer 31 and the second electrode layer 32, the reflectivity of the electro-dimming layer 34 to the infrared light may be changed.

Based on this, in a case where the dimming substrate 3 is applied to the dimming glass 100, a reflectivity of the dimming glass 100 to the infrared light may be adjusted. Therefore, in summer, the first potential difference between the first electrode layer 31 and the second electrode layer 32 may be adjusted to increase the reflectivity of the dimming glass 100 to the infrared light and reduce infrared light entering a room after passing through the dimming glass 100, thereby achieving an effect of reducing a temperature in the room; and in winter, the first potential difference between the first electrode layer 31 and the second electrode layer 32 may be adjusted to decrease the reflectivity of the dimming glass 100 to the infrared light and increase the infrared light entering the room after passing through the dimming glass 100, thereby achieving an effect of keeping warm.

In some embodiments, the material of the electro-dimming layer 34 includes a polymer, and a monomer of the polymer is 3,4-(2,2-dimethyl-propylenedioxy) thiophene (ProDOT-Me2). That is to say, the polymer is formed by polymerizing the monomer with the following structural formula, and the structural formula of the monomer is as follows:

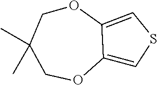

For example, the first electrode layer 31 or the second electrode layer 32, which may be, for example, an ITO layer coated on a surface of a base, is soaked in a solution of the monomer. The first electrode layer 31 or the second electrode layer 32 serving as a working electrode, an auxiliary electrode, and a reference electrode (e.g., a wire-like silver electrode) are all soaked in the solution of the monomer. The monomer is polymerized to form the polymer on the working electrode by using cyclic voltammetry at a potential within a range of −1.2 v to 1.2 v inclusive, thereby obtaining the electro-dimming layer 34 in the embodiments of the present disclosure. Herein, the cyclic voltammetry refers to controlling a potential of the working electrode to perform scanning one or more times in a triangular waveform at different rates over time.

Or, a surface of the first electrode layer 31 or the second electrode layer 32 is coated with a solution of the above polymer, and the electro-dimming layer 34 made of polymer is formed after drying treatment.

In some examples, after the first potential difference in a range of −1.5 V to 0 V inclusive is applied between the first electrode layer 31 and the second electrode layer 32, the polymer undergoes a chemical reaction, and in the case where different first potential differences are applied, products generated after the chemical reaction of the polymer are different, so that the electro-dimming layer 34 may change its reflectivity to the infrared light in response to different first potential differences. For example, the first potential difference applied between the first electrode layer 31 and the second electrode layer 32 is −1.5 V, −1.0 V, −0.5 V, or 0 V. The embodiments of the present disclosure do not limit a specific value of the first potential difference, as long as it enables the polymer to undergo the chemical reaction to achieve an effect of changing the reflectivity of the electro-dimming layer 34 to the infrared light. In addition, the embodiments of the present disclosure do not limit a manner of applying the first potential difference between the first electrode layer 31 and the second electrode layer 32, either. For example, a certain potential may be applied to only one of the first electrode layer 31 and the second electrode layer 32, and no potential is applied to the other electrode layer (i.e., the other electrode layer being grounded and at a zero potential), so that a certain potential difference can be formed between the two electrode layers; alternatively, different potentials (e.g., potentials with different values) may be applied to the two electrode layers, as long as a certain potential difference can be formed between the two electrode layers.

Herein, the first potential difference applied being 0 V refers to a case where no potential difference is applied between the first electrode layer 31 and the second electrode layer 32, for example, the dimming substrate 3 is in a de-energized state.

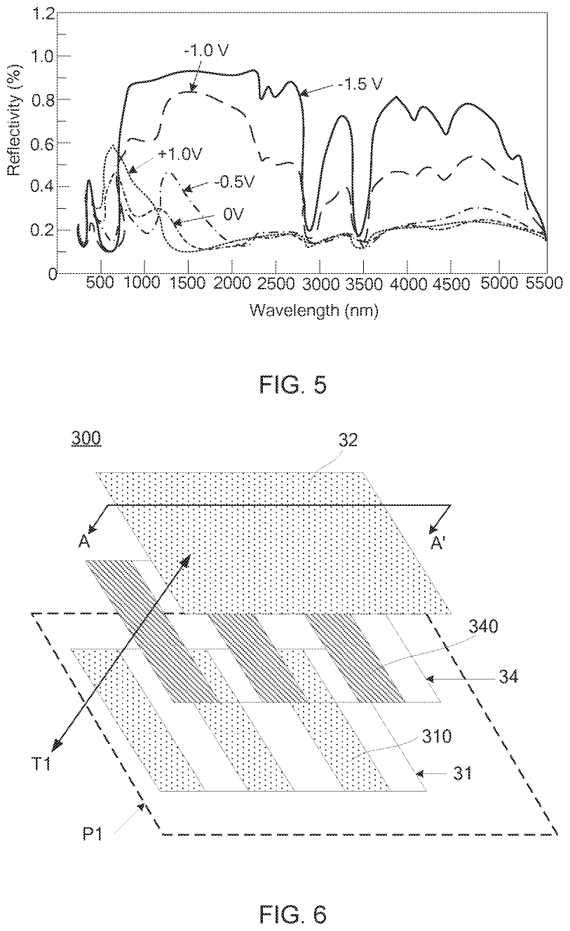

FIG. 5 is a spectrogram of the reflectivites of the electro-dimming layer 34 to the light in the case where different first potential differences are applied between the first electrode layer 31 and the second electrode layer 32. It can be seen from FIG. 5 that, in an infrared light region (a wavelength λ being in a range of 760 nm to 1 mm inclusive), the reflectivities of the electro-dimming layer 34 to the infrared light are different in the case where the first potential differences are different. For example, for near-infrared light, i.e., infrared light with a wavelength λ in a range of 800 nm to 2500 nm inclusive, in a case where the first potential difference is −1.5 V, a reflectivity of the electro-dimming layer 34 to the infrared light in the wavelength range is approximately 90%; in a case where the first potential difference is −1.0 V, a reflectivity of the electro-dimming layer 34 to the infrared light in the wavelength range is approximately 85%; in a case where the first potential difference is −0.5 V, a reflectivity of the electro-dimming layer 34 to the infrared light in the wavelength range is approximately 50%; and in a case where the first potential difference is 0 V, a reflectivity of the electro-dimming layer 34 to the infrared light in the wavelength range is approximately 20%. Since heat carried by the near-infrared light with the wavelength λ in the range of 800 nm to 2500 nm inclusive accounts for a large portion of heat carried by the infrared light, the electro-dimming layer 34 may reflect most of heat of the sunlight by reflecting the near-infrared light with the wavelength λ in the range of 800 nm to 2500 nm inclusive.

It will be noted that, the higher the reflectivity of the electro-dimming layer 34 to the infrared light is, the smaller a shading coefficient thereof is, and the better a performance of blocking the heat of the sunlight from radiating into a room is, that is, the radiation of the sunlight into the room is decreased, so that the effect of reducing the temperature in the room may be achieved. In contrast, the lower the reflectivity of the electro-dimming layer 34 to the infrared light is, the larger the shading coefficient thereof is, and the better a performance of the heat of the sunlight radiating into the room is, that is, the radiation of the sunlight into the room is increased, so that the effect of keeping warm may be achieved.

In addition, it will also be noted that, the color change reaction of the material of the electro-dimming layer 34 in the embodiments of the present disclosure is reversible, that is, when the first potential difference (e.g., −1.5 V) is applied between the first electrode layer 31 and the second electrode layer 32, the material of the electro-dimming layer 34 reacts to reflect the infrared light; and under another condition, for example, when a potential difference (e.g., +1.5 V) opposite to the first potential difference is applied between the first electrode layer 31 and the second electrode layer 32, the material of the electro-dimming layer 34 undergoes a reverse reaction, so that the material of the electro-dimming layer 34 may be restored to a substance before it undergoes the color change reaction (i.e., making it in a faded state). Thus, the color change reaction of the material of the electro-dimming layer 34 may be cycled multiple times, so that the dimming substrate 3 may be used continuously.

In some embodiments, as shown in FIG. 4B, the infrared light dimming structure 300 further includes a first ion transport layer 33 and a first ion storage layer 35 disposed between the first electrode layer 31 and the second electrode layer 32. The first ion transport layer 33, the first ion storage layer 35 and the electro-dimming layer 34 are stacked, and the first ion storage layer 35 is in direct contact with at least the first ion transport layer 33.

The embodiments of the present disclosure do not limit a relative positional relationship between the electro-dimming layer 34 and the first ion transport layer 33, as long as they are stacked. For example, the first ion transport layer 33 is disposed farther away from the first electrode layer 31 than the electro-dimming layer 34. For another example, the first ion transport layer 33 is disposed closer to the first electrode layer 31 than the electro-dimming layer 34. FIG. 4B shows an example in which the first ion transport layer 33 is disposed farther away from the first electrode layer 31 than the electro-dimming layer 34.

In addition, the embodiments of the present disclosure do not limit a relative positional relationship between the first ion storage layer 35 and the first ion transport layer 33, as long as they are stacked and in direct contact, and it is ensured that the first ion transport layer 33 is disposed between the first ion storage layer 35 and the electro-dimming layer 34. In this way, ions in the first ion storage layer 35 can be transported to the electro-dimming layer 34 through the first ion transport layer 33, so that the material of he electro-dimming layer 34 can undergo a reversible color change reaction.

For example, in a case where the first ion transport layer 33 is disposed farther away from the first electrode layer 31 than the electro-dimming layer 34, the first ion storage layer 35 is disposed between the first ion transport layer 33 and the second electrode layer 32. For another example, in a case where the first ion transport layer 33 is disposed closer to the first electrode layer 31 than the electro-dimming layer 34, the first ion storage layer 35 is disposed between the first ion transport layer 33 and the first electrode layer 31. FIG. 4B shows an example in which the first ion storage layer 35 is disposed between the first ion transport layer 33 and the second electrode layer 32.

In the embodiments of the present disclosure, a function of the first ion storage layer 35 is mainly to store and provide ions required for the reversible color change reaction of the electro-dimming layer 34, so that a color change reaction process of the electro-dimming layer 34 may be maintained in balance. Therefore, a material of the first ion storage layer 35 has a reversibility of ion insertion, a good transparency and a fast reaction speed, and is a mixed conductor of the electrons and the ions.

For example, the material of the first ion storage layer 35 includes at least one of vanadium pentoxide, iridium dioxide and nickel oxide, which is not limited in the embodiments of the present disclosure.

In the embodiments of the present disclosure, a material of the first ion transport layer 33 may be a solid electrolyte material or a liquid electrolyte material. For example, the material of the first ion transport layer 33 includes at least one of perfluorosulfonic acid (Nafion), 2-acrylamido-2-methylpropanesulfonic acid (AMPS), polyethylene oxide (PEO), a lithium perchlorate solution and a sodium perchlorate solution.

In some embodiments, the dimming substrate 3 further includes a first base. The first electrode layer 31 or the second electrode layer 32 is disposed on the first base. FIG. 4C shows an example in which the first electrode layer 31 is disposed on the first base 30.

For example, the first base 30 is a rigid base, such as at least one of glass and quartz. For another example, the first base 30 is a flexible base, such as at least one of PET, TAO, COP, and PI, which is not limited in the embodiments of the present disclosure.

In this way, the layers in the dimming substrate 3 may be sequentially formed on the first base 30, so that the dimming substrate 3 may be manufactured separately, and is convenient to store and transport.

In a case where the dimming substrate 3 is applied to the dimming glass 100, and the dimming substrate 3 is connected to the first transparent sheet 1 of the dimming glass 100, the first base 30 may be connected to the first transparent sheet 1 of the dimming glass 100. Alternatively, in some other embodiments, the first transparent sheet 1 may serve as a base for supporting the layers in the dimming substrate 3 shown in FIG. 4A, that is, the layers in the dimming substrate 3 may be sequentially formed on the first transparent sheet 1.

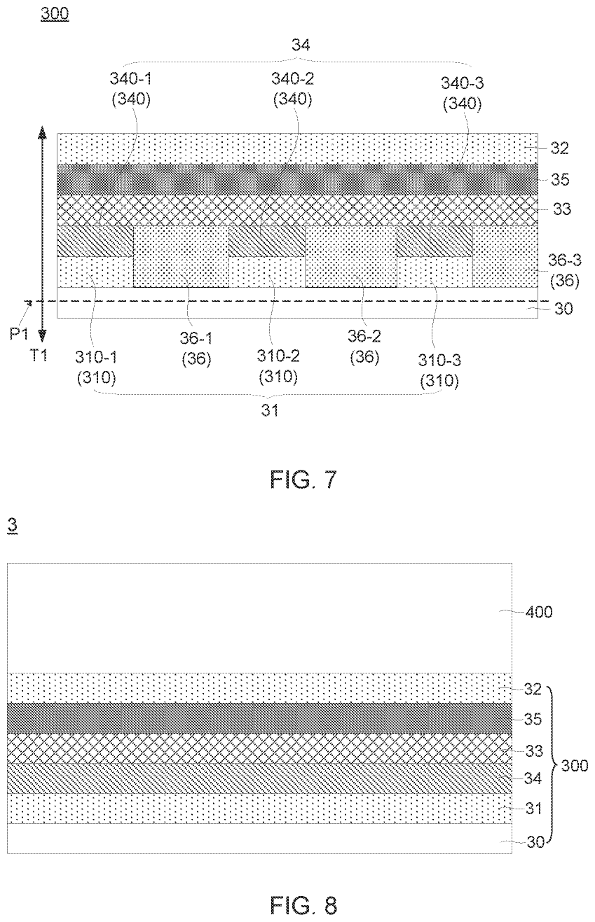

In some embodiments, as shown in FIGS. 6 and 7, the electro-dimming layer 34 includes a plurality of electro-dimming patterns 340 arranged at intervals, and the first electrode layer 31 includes a plurality of first electrode patterns 310 arranged at intervals. In this case, the second electrode layer 32 may be a whole layer (i.e., an electrode layer that is not patterned) to simplify a manufacturing process. Of course, in some other embodiments, it is also possible that the second electrode layer 32 includes a plurality of first electrode patterns 310 arranged at intervals. In this case, the first electrode layer 31 is a whole layer (i.e., an electrode layer that is not patterned) to simplify the manufacturing process, which is not limited in the embodiments of the present disclosure. FIGS. 6 and 7 show examples in which the first electrode layer 31 includes the plurality of first electrode patterns 310 and the second electrode layer 32 is the whole electrode layer. The plurality of electro-dimming patterns 340 arranged at intervals shown in FIG. 6 are each strip-shaped, and are arranged in a line. Correspondingly, the plurality of first electrode patterns 310 are also each strip-shaped, and are also arranged in a line. The embodiments of the present disclosure are not limited thereto. Each electro-dimming pattern 340 may also be block-shaped, for example, the plurality of electro-dimming patterns 340 are arranged in a matrix, and a corresponding first electrode pattern 310 may also be block-shaped.

In the embodiments of the present disclosure, a potential applied to the second electrode layer 32 may be a constant potential, and potentials applied to the plurality of first electrode patterns 310 included in the first electrode layer 31 may be the same or different.

In some examples, in a case where the potentials applied to the plurality of first electrode patterns 310 included in the first electrode layer 31 are the same, the products generated after the color change reaction of the material of the plurality of electro-dimming patterns 340 are the same, so that the reflectivities of the electro-dimming patterns 340 to the infrared light are the same. In some other examples, in a case where the potentials applied to the plurality of first electrode patterns 310 included in the first electrode layer 31 are different, the products generated after the color change reaction of the material of the electro-dimming patterns 340 corresponding to the first electrode patterns 310 with different applied potentials are different, so that the reflectivities of the electro-dimming patterns 340 to the infrared light are different. Therefore, by applying different potentials to different first electrode patterns 310, the electro-dimming patterns 340 corresponding to the first electrode patterns 310 may undergo the color change reaction to generate different products, thereby achieving a partitioned adjustment of a reflectivity of the dimming substrate 3 to the infrared light therein.

For example, in the dimming substrate 3, the second electrode layer 32 is grounded, that is, a potential of 0 V is applied to the second electrode layer 32, and a potential of −1.5 V is applied to a part of the first electrode patterns 310, and a potential of −1.0 V is applied to the other part of the first electrode patterns 310. As a result, a reflectivity of electro-dimming patterns 340 corresponding to the first electrode patterns 310 to which the potential of −1.5 V is applied to the infrared light is 90%, and a reflectivity of electro-dimming patterns 340 corresponding to the first electrode patterns 310 to which the potential of −1.0 V is applied to the infrared light is 50%. Based on this, in the case where the dimming substrate 3 is applied to the dimming glass 100, a same dimming glass 100 may achieve a partitioned adjustment of the reflectivity of the infrared light.

For another example, in the dimming substrate 3, the second electrode layer 32 is grounded, and a potential of −1.5 V is applied to a part of the first electrode patterns 310, and no potential is applied to the other part of the first electrode patterns 310, that is, a potential of 0 V is applied. As a result, a reflectivity of electro-dimming patterns 340 corresponding to the first electrode patterns 310 to which the potential of −1.5 V is applied to the infrared light is 90%, and a reflectivity of electro-dimming patterns 340 corresponding to the first electrode patterns 310 to which the potential of 0 V is applied to the infrared light is 20%. Based on this, in the case where the dimming substrate 3 is applied to the dimming glass, in the same dimming glass 100, an effect of reducing a temperature may be achieved in a part of a region, and an effect of keeping warm may be achieved in the other part of the region. Therefore, application scenarios of the dimming glass 100 may be expanded, for example, the dimming glass 100 is applied to a whole glass wall of a restaurant, so that requirements of guests at different tables for an ambient temperature may be met by controlling the dimming glass.

It will be understood that a distance between any two adjacent first electrode patterns 310 may be the same or different, and a distance between any two adjacent electro-dimming patterns 340 may be the same or different. The embodiments of the present disclosure do not limit this, as long as there is an overlapping region between an orthogonal projection of each electro-dimming pattern 340 on a first plane P1 perpendicular to a thickness direction T1 of the infrared light dimming structure 300 and an orthogonal projection of a respective one of the plurality of first electrode patterns 310 on the first plane P1, as shown in FIGS. 6 and 7. FIG. 7 is a sectional diagram of the infrared light dimming structure taken along the line A-A′ in FIG. 6. It will be noted that, in order to illustrate the first electrode patterns 310 and the electro-dimming patterns 340 more clearly, the first ion storage layer 35 and the first ion transport layer 33 are not shown in FIG. 6.

FIGS. 6 and 7 illustrate only three electro-dimming patterns (340-1, 340-2, and 340-3) and three corresponding first electrode patterns (310-1, 310-2, and 310-3), and show an example in which the orthogonal projection of each electro-dimming pattern 340 on the first plane P1 completely overlaps with the orthogonal projection of the respective one of the plurality of first electrode patterns 310 on the first plane P1. For example, an orthogonal projection of the electro-dimming pattern 340-1 on the first plane P1 completely overlaps with an orthogonal projection of the first electrode pattern 310-1 on the first plane P1, an orthogonal projection of the electro-dimming pattern 340-2 on the first plane P1 completely overlaps with an orthogonal projection of the first electrode pattern 310-2 on the first plane P1, and an orthogonal projection of the electro-dimming pattern 340-3 on the first plane P1 completely overlaps with an orthogonal projection of the first electrode pattern 310-3 on the first plane P1.

The embodiments of the present disclosure do not limit the overlapping region between the orthogonal projections of the electro-dimming pattern 340 and the first electrode pattern 310 on the first plane P1. The orthogonal projections may completely overlap or partially overlap, that is, the orthogonal projection of the electro-dimming pattern 340 on the first plane P1 and the orthogonal projection of the first electrode pattern 310 on the first plane P1 only partially overlap.

Herein, it will be noted that, since the material of the electro-dimming layer 34 undergoes the color change reaction in response to the electrons transported between the first electrode layer 31 and the second electrode layer 32, in the case where the first electrode layer 31 includes the plurality of first electrode patterns 310 arranged at intervals, only a portion of each electro-dimming pattern 340 that overlaps with the corresponding first electrode pattern 310 undergoes the color change reaction and changes its reflectivity to the infrared light due to action of the first potential difference.

Based on this, as shown in FIG. 7, the infrared light dimming structure 300 further includes a plurality of first barrier walls 36 arranged at intervals. A corresponding first barrier wall 36 of the plurality of first barrier walls 36 is provided between any two adjacent first electrode patterns 310, and the first barrier wall 36 is located between two electro-dimming patterns 340 corresponding to the two adjacent first electrode patterns 310. The first barrier wall 36 may separate the two adjacent first electrode patterns 310 to avoid crosstalk between potentials applied to the two adjacent first electrode patterns 310, and also enables the electro-dimming patterns 340 to be manufactured through a spray coating method, thereby simplifying a manufacturing process of the electro-dimming patterns 340.

For example, as shown in FIG. 7 , a first barrier wall 36-1 is provided between the first electrode pattern 310-1 and the first electrode pattern 310-2, that is to say, the first barrier wall 36-1 is located between the first electrode pattern 310-1 and the first electrode pattern 310-2; and the first barrier wall 36-1 is further located between the electro-dimming pattern 340-1 and the electro-dimming pattern 340-2. A first barrier wall 36-2 is provided between the first electrode pattern 310-2 and the first electrode pattern 310-3, that is to say, the first barrier wall 36-2 is located between the first electrode pattern 310-2 and the first electrode pattern 310-3; and the first barrier wall 36-2 is further located between the electro-dimming pattern 340-2 and the electro-dimming pattern 340-3.

The numbers of the electro-dimming patterns 340 and the first electrode patterns 310 are not limited in the embodiments of the present disclosure, and may be set as needed. It will be understood that, in a case where one electro-dimming pattern 340 corresponds to one first electrode pattern 310, the number of the electro-dimming patterns 340 is equal to the number of the first electrode patterns 310.

In some embodiments, in a case where the electro-dimming layer 34 includes the plurality of electro-dimming patterns 340 arranged at intervals, the first ion transport layer 33 may also include a plurality of first ion transport patterns, and there is an overlapping region between an orthogonal projection of each first ion transport pattern on the first plane P1 and an orthogonal projection of a respective electro-dimming pattern 340 on the first plane P1; and/or, the first ion storage layer 35 may also include a plurality of ion storage patterns, and there is an overlapping region between an orthogonal projection of each ion storage pattern on the first plane P1 and an orthogonal projection of a respective electro-dimming pattern 340 on the first plane P1 Of course, the first ion transport layer 33 may also be a whole layer, and/or, the first ion storage layer 35 may also be a whole layer. FIGS. 6 and 7 show an example in which the first ion transport layer 33 and the first ion storage layer 35 are each a whole layer.

It will be noted that, in a case where the first ion transport layer 33 includes the plurality of first ion transport patterns, the first barrier wall 36 disposed between two adjacent first electrode patterns 310 is not only located between the two electro-dimming patterns 340 corresponding to the two adjacent first electrode patterns 310, but also located between two first ion transport patterns corresponding to the two electro-dimming patterns 340. That is, the first barrier wall 36 has a large thickness. In a case where the first ion storage layer 35 includes the plurality of first ion storage patterns, the first barrier wall 36 disposed between the two adjacent first electrode patterns 310 is not only located between two electro-dimming patterns 340 corresponding to the two adjacent first electrode patterns 310, but also located between two first ion storage patterns corresponding to the two electro-dimming patterns 340. That is, the first barrier wall 36 has a large thickness.

In some embodiments, as shown in FIG. 8, the dimming substrate 3 further includes a visible light dimming structure 400 stacked with the infrared light dimming structure 300. The visible light dimming structure 400 is configured to be reversibly switchable between at least a first transparent state and a first color rendering state. The first color rendering state enables the visible light dimming structure 400 to block transmission of a part of the visible light in the state, so that the dimming substrate may adjust a transmittance of the visible light through the visible light dimming structure 400, an effect of adjusting indoor light or preventing peeping to protect privacy may be achieved, and a heat insulation effect to a certain degree may be achieved.

The embodiments of the present disclosure do not limit relative positions of the layers in the infrared light dimming structure 300 and the visible light dimming structure 400, as long as they are stacked. For example, as shown in FIG. 8, the second electrode layer 32 in the infrared light dimming structure 300 is closer to the visible light dimming structure 400 than the first electrode layer 31. For another example, the first electrode layer 31 in the infrared light dimming structure 300 is closer to the visible light dimming structure 400 than the second electrode layer 32.

In this way, the dimming substrate 3 may adjust its transmittance to the visible light while adjusting its reflectivity to the infrared light. For example, in a case where the dimming substrate 3 is applied to the dimming glass, and the dimming glass is applied to a building, the infrared light dimming structure 300 and the visible light dimming structure 400 may be simultaneously turned on in summer, so that the infrared light dimming structure 300 has a high reflectivity to the infrared light, and the visible light dimming structure 400 is in the first color rendering state, thereby blocking the transmission of a part of the visible light, and achieving a double heat insulation effect of the dimming glass.

In addition, as shown in FIG. 5, in a case where the first potential difference applied between the first electrode layer 31 and the second electrode layer 32 is in the range of -1.5 V to 0 V inclusive, a transmittance of the electro-dimming layer 34 to the visible light (with a wavelength λ in a range of 380 nm to 700 nm inclusive) is above 40%, which may ensure that influence on the transmittance of the infrared light dimming structure 300 to the visible light is small when the reflectivity of the infrared light dimming structure 300 to the infrared light is adjusted.

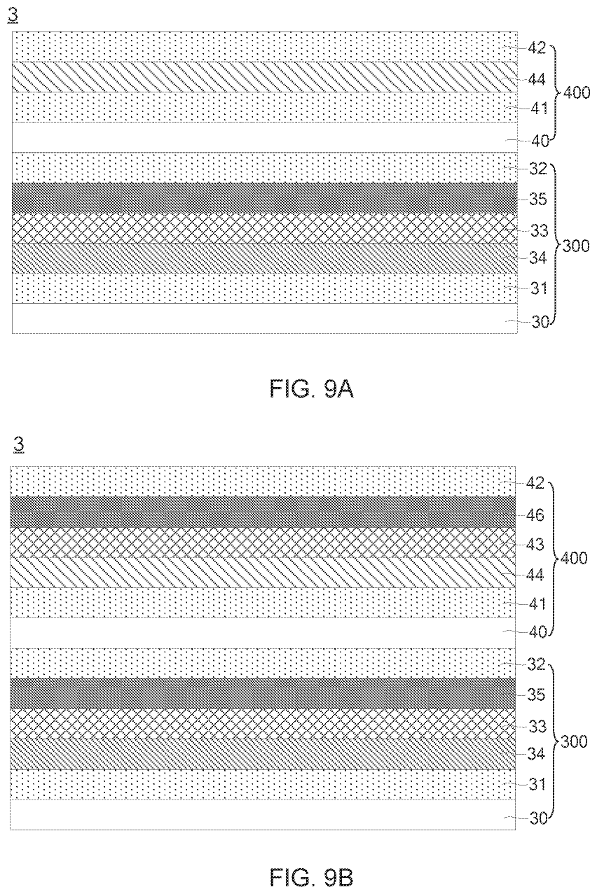

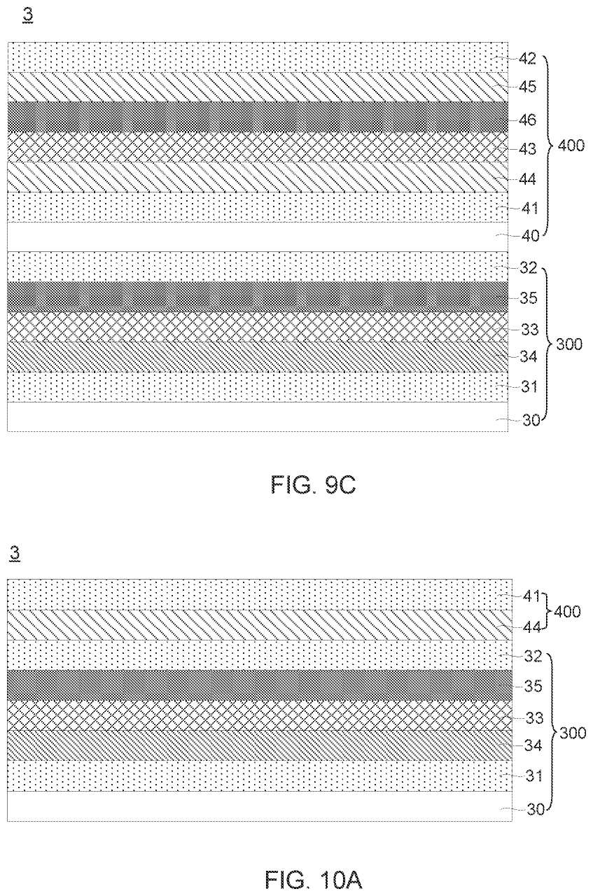

In some embodiments, as shown in FIG. 9A, the visible light dimming structure 400 includes a third electrode layer 41, a fourth electrode layer 42 and a first electrochromic layer 44. The fourth electrode layer 42 is disposed opposite to the third electrode layer 41. The first electrochromic layer 44 is disposed between the third electrode layer 41 and the fourth electrode layer 42, and is configured to be reversibly switchable between the first transparent state and the first color rendering state in response to a second potential difference applied between the third electrode layer 41 and the fourth electrode layer 42.

For example, a material of he first electrochromic layer 44 may be an inorganic material, such as at least one of a tungsten oxide, a molybdenum oxide, and titanium oxide; alternatively, the material of the first electrochromic layer 44 may be an organic material, such as at least one of polythiophene, viologen compounds, tetrathiafulvalene, and metal phthalocyanine.

For example, the third electrode layer 41 and the fourth electrode layer 42 in the embodiments of the present disclosure are both transparent electrode layers, which may reduce influences of the third electrode layer 41 and the fourth electrode layer 42 on a transmittance of the visible light. For materials of the transparent electrode layers, reference may be made to the materials of the transparent electrode layers in the above embodiments, and details will not be repeated herein. In addition, the materials of the third electrode 41 and the fourth electrode 42 may be the same or different. Moreover, the material of the third electrode layer 41 may be the same as or different from the material of the first electrode layer 31 or the material of the second electrode layer 32, and the material of the fourth electrode layer 42 may also be the same as or different from the material of the first electrode layer 31 or the material of the second electrode layer 32, which are not limited in the embodiments of the present disclosure, as long as an electric field may be formed between the first electrode layer 31 and the second electrode layer 32, and an electric field may be formed between the third electrode layer 41 and the fourth electrode layer 42, and the two electric fields do not affect each other.

In the embodiments of the present disclosure, after the second potential difference is applied between the third electrode layer 41 and the fourth electrode layer 42, electrons are transported between the third electrode layer 41 and the fourth electrode layer 42, and the material of the first electrochromic layer 44 undergoes a color change reaction (i.e., changing a transmittance of the first electrochromic layer 44 to the visible light) such as an oxidation-reduction reaction during the transport of the electrons, so that the first electrochromic layer 44 reversibly switches between the first transparent state and the first color rendering state. In addition, in a case where different second potential differences are applied between the third electrode layer 41 and the fourth electrode layer 42, products generated after the color change reaction of the material of the first electrochromic layer 44 are different, so that colors displayed by the first electrochromic layer 44 are different, and the transmittance of the first electrochromic layer 44 to the visible light is changed.

In the embodiments of the present disclosure, the first color rendering state is a state that the first electrochromic layer 44 presents after the material thereof undergoes the color change reaction in response to the second potential difference. The first transparent state is a state of the first electrochromic layer 44 before the material thereof undergoes the color change reaction in response to the second potential difference, that is, the visible light dimming structure 400 can transmit most of the visible light in the first transparent state.

Based on this, in the case where the dimming substrate 3 is applied to the dimming glass 100, the transmittance of the dimming substrate 3 to the visible light and the reflectivity of the dimming substrate 3 to the infrared light may be simultaneously adjusted. For example, in summer, the infrared light dimming structure 300 and the visible light dimming structure 400 may be simultaneously turned on, that is, the first potential difference is applied between the first electrode layer 31 and the second electrode layer 32 at a same time when the second potential difference is applied between the third electrode layer 41 and the fourth electrode layer 41, so that the dimming glass 100 may achieve the double heat insulation effect.

In some examples, the second potential difference in a range of 2 V to 4 V inclusive is applied between the third electrode layer 41 and the fourth electrode layer 42. For example, the second potential difference applied between the third electrode layer 41 and the fourth electrode layer 42 may be 2 V, 3 V, or 4 V.

For example, in a case where the second potential difference applied between the third electrode layer 41 and the fourth electrode layer 42 is 2 V, a transmittance of a product generated after the color change reaction of the material of the first electrochromic layer 44 to the visible light is high; and in a case where the second potential difference applied between the third electrode layer 41 and fourth electrode layer 42 is 4 V a transmittance of a product generated after the color change reaction of the material of the first electrochromic layer 44 to the visible light is low. Therefore, the transmittance of the first electrochromic layer 44 to the visible light may be adjusted by controlling a magnitude of the second potential difference applied between the third electrode layer 41 and the fourth electrode layer 42.

In addition, it will also be noted that, the color change reaction of the material of the first electrochromic layer 44 in the embodiments of the present disclosure is reversible, that is, when the second potential difference (e.g., 2 V) is applied between the third electrode layer 41 and the fourth electrode layer 42, the material of the first electrochromic layer 44 reacts to present the first color rendering state and adjust its transmittance to the visible light; and under another condition, for example, when a potential difference (e.g., -2 V) opposite to the second potential difference is applied between the third electrode layer 41 and the fourth electrode layer 42, the material of the first electrochromic layer 44 undergoes a reverse reaction, so that the material of the first electrochromic layer 44 may be restored to a substance before it undergoes the color change reaction (i.e., making it in a faded state). Thus, the color change reaction of the material of the first electrochromic layer 44 may be cycled multiple times, so that the dimming substrate 3 may be used continuously.

In some embodiments, as shown in FIG. 9B, the visible light dimming structure 400 further includes a second ion transport layer 43 and a second ion storage layer 46 that are disposed between the third electrode layer 41 and the third electrode layer 42. The second ion transport layer 43 and the first electrochromic layer 44 are stacked.

The embodiments of the present disclosure do not limit a relative positional relationship between the second ion transport layer 43 and the first electrochromic layer 44, as long as they are stacked. For example, the second ion transport layer 43 is disposed farther away from the third electrode layer 41 than the first electrochromic layer 44; alternatively, the second ion transport layer 43 is disposed closer to the third electrode layer 41 than the first electrochromic layer 44. FIG. 9B shows an example in which the second ion transport layer 43 is disposed farther away from the third electrode layer 41 than the first electrochromic layer 44.

In addition, the embodiments of the present disclosure do not limit a relative positional relationship between the second ion storage layer 46 and the second ion transport layer43, as long as they are stacked, and ions in the second ion storage layer 46 can be transported to the first electrochromic layer 44 through the second ion transport layer 43, so that the material of the first electrochromic layer 44 can undergo the reversible color change reaction. For example, the second ion transport layer 43 is disposed closer to the first electrochromic layer 44 than the second ion storage layer 46, that is, the second ion transport layer 43 is disposed between the second ion storage layer 46 and the first electrochromic layer 44. For another example, the second ion transport layer 43 is disposed farther away from the first electrochromic layer 44 than the second ion storage layer 46, that is, the second ion storage layer 46 is disposed between the second ion transport layer 43 and the first electrochromic layer 44. FIG. 9B shows an example in which the second ion transport layer 43 is disposed closer to the first electrochromic layer 44 than the second ion storage layer 46, and they are in direct contact.

In the embodiments of the present disclosure, a function of the second ion storage layer 46 is mainly to store and provide ions required for the reversible color change reaction of the first electrochromic layer 44, so that a color change reaction process of the first electrochromic layer 44 may be maintained in balance. Therefore, a material of the second ion storage layer 46 has a reversibility of ion insertion, a good transparency and a fast reaction speed, and is a mixed conductor of the electrons and the ions.

For example, the material of the second ion storage layer 46 includes at least one of vanadium pentoxide, iridium dioxide and nickel oxide, which is not limited in the embodiments of the present disclosure.

In the embodiments of the present disclosure, a material of the second ion transport layer 43 may be a solid electrolyte material or a liquid electrolyte material. For example, the material of the second ion transport layer 43 includes at least one of Nafion, AMPS, PEO, a lithium perchlorate solution and a sodium perchlorate solution.

In some embodiments, the visible light dimming structure 400 further includes a second base, a material of which is an insulating material. The second base is located between the third electrode layer 41 or the fourth electrode layer 42 in the visible light dimming structure 400 and the infrared light dimming structure 300, so that the electrode layers in the visible light dimming structure 400 and the electrode layers in the infrared light dimming structure 300 that are close to each other are insulated from each other. As a result, it is possible to prevent the electric field formed between the third electrode layer 41 and the fourth electrode layer 42 in the visible light dimming structure 400 and the electric field formed between the second electrode layer 32 and the first electrode layer 31 in the infrared light dimming structure 300 from affecting each other, and separate control of the two electric fields is achieved.

For example, as shown in FIG. 9A, the visible light dimming structure 400 and the infrared light dimming structure 300 are stacked, the third electrode layer 41 in the visible light dimming structure 400 is closer to the infrared light dimming structure 300 than the fourth electrode layer 42, and the second electrode layer 32 in the infrared light dimming structure 300 is closer to the visible light dimming structure 400 than the first electrode layer 31. The second base 40 is disposed between the third electrode layer 41 and the second electrode layer 32.

The material of the second base 40 is the insulating material which is not limited in the embodiments of the present disclosure. For example, similar to the first base 30, the second base 40 is a rigid base, such as at least one of glass and quartz. For another example, the first base 40 is a flexible base, such as at least one of PET, TAC, COP, and PI. In this case, the third electrode layer 41, the first electrochromic layer 44, and the fourth electrode layer 42 in the visible light dimming structure 400 may be sequentially formed on the second base 40, so that the visible light dimming structure 400 may be manufactured separately, and is convenient to store and transport. Of course, the material of the second base 40 may also include the insulating material such as silicon nitride. In this case, the second base 40 may be formed directly on a surface of an electrode layer (e.g., the third electrode layer 41) in the visible light dimming structure 400, or may be formed directly on a surface of an electrode layer (e.g., the second electrode layer 32) in the infrared light dimming structure 300, which may simplify a manufacturing process of the dimming substrate 3.

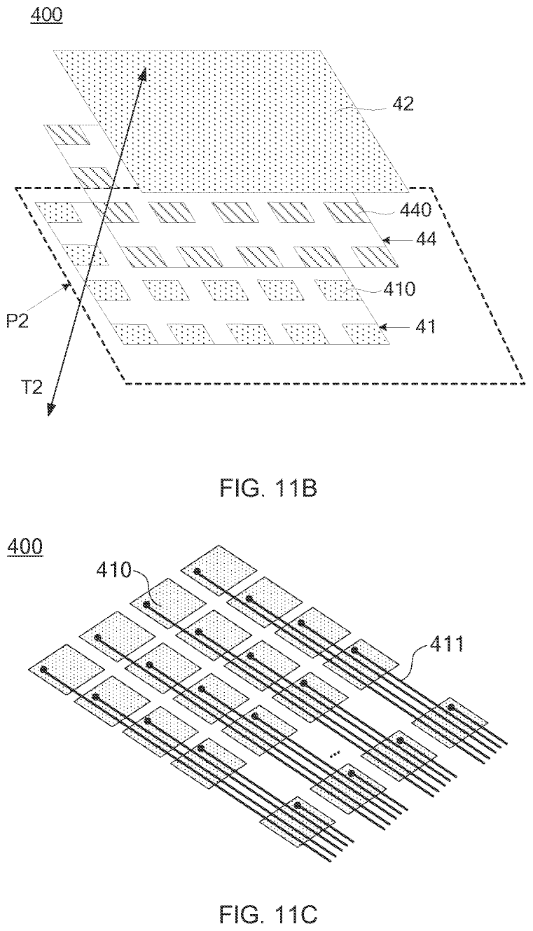

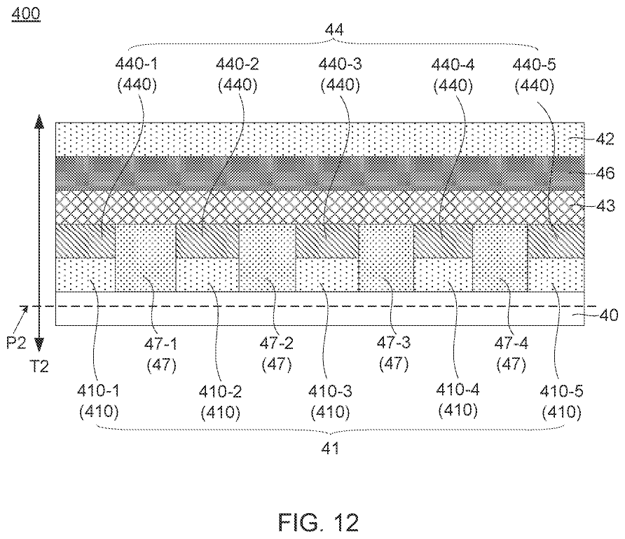

In some embodiments, as shown in FIGS. 11A, 113 and 12, the first electrochromic layer 44 includes a plurality of first electrochromic patterns 440 arranged at intervals, and the third electrode layer 41 includes a plurality of second electrode patterns 410 arranged at intervals. In this case, the fourth electrode layer 42 may be a whole layer (i.e., an electrode layer that is not patterned) to simplify a manufacturing process. Of course, it is also possible that the fourth electrode layer 42 include a plurality of second electrode patterns 410 arranged at intervals. In this case, the third electrode layer 41 is a whole layer (i.e., an electrode layer that is not patterned) to simplify a manufacturing process, which is not limited in the embodiments of the present disclosure. FIGS. 11A, 11B and 12 show examples in which the third electrode layer 41 includes a plurality of second electrode patterns 410 arranged at intervals, and the fourth electrode layer 42 is a whole electrode layer.

In the embodiments of the present disclosure, a potential applied to the fourth electrode layer 42 may be a constant potential, and potentials applied to the plurality of second electrode patterns 410 included in the third electrode layer 41 may be the same or different.

In some examples, as shown in FIG. 11A, the plurality of first electrochromic patterns 440 arranged at intervals are each strip-shaped, and are arranged in a line, correspondingly, the plurality of second electrode pattern 410 are also each strip-shaped, and are also arranged in a line. In this case, a constant potential is applied to the fourth electrode layer 42, and different potentials are applied to the plurality of second electrode patterns 410, so that the visible light dimming structure 400 may achieve a partitioned adjustment of the transmittance of the visible light.

In some other examples, as shown in FIG. 11B, the plurality of first electrochromic patterns 440 are arranged in an array, and each first electrochromic patterns 440 is block-shaped; correspondingly, the plurality of second electrode patterns 410 are also arranged in an array, and each second electrode pattern 410 is also block-shaped. In this case, by applying a constant potential to the fourth electrode layer 42 and applying different potentials to the plurality of second electrode patterns 410, color rendering states of first electrochromic patterns 440 corresponding to different second electrode patterns 410 may be controlled, and by using the color rendering states of different first electrochromic patterns 440, the visible light dimming structure 400 may achieve display of a simple image (e.g., characters).

In the embodiments of the present disclosure, as shown in FIGS. 11A, 11B and 12, there is an overlapping region between an orthogonal projection of each second electrode pattern 410 on a second plane P2 perpendicular to a thickness direction T2 of the visible light dimming structure 400 and an orthogonal projection of a respective one of the plurality of first electrochromic patterns 440 on the second plane P2. In the embodiments of the present disclosure, since the visible light dimming structure 400 and the infrared light dimming structure 300 are stacked, the thickness direction T2 of the visible light dimming structure 400 is parallel to the thickness direction T1 of the infrared light dimming structure 300, and the second plane P2 is parallel to the first plane P1. FIG. 12 is a sectional diagram of the visible light dimming structure 400 taken along the line B-B′ in FIG. 11A, It will be noted that, in order to illustrate the second electrode patterns 410 and the first electrochromic patterns 440 more clearly, the second ion storage layer 46 and the second ion transport layer 43 are not shown in FIG. 11A.

FIG. 12 illustrates only five first electrochromic patterns 440 (440-1, 440-2, 440-3, 440-4, and 440-5) and five corresponding second electrode patterns 410 (410-1, 410-2, 410-3, 410-4, and 410-5), and shows an example in which an orthogonal projection of each first electrochromic pattern 440 on the second plane P2 completely overlaps with an orthogonal projection of the respective one of the plurality of second electrode patterns 410 on the second plane P2. For example, an orthogonal projection of the first electrochromic pattern 440-1 on the second plane P2 completely overlaps with an orthogonal projection of the second electrode pattern 410-1 on the second plane P2, an orthogonal projection of the first electrochromic pattern 440-2 on the second plane P2 completely overlaps with an orthogonal projection of the second electrode pattern 410-2 on the second plane P2, an orthogonal projection of the first electrochromic pattern 440-3 on the second plane P2 completely overlaps with an orthogonal projection of the second electrode pattern 410-3 on the second plane P2, an orthogonal projection of the first electrochromic pattern 440-4 on the second plane P2 completely overlaps with an orthogonal projection of the second electrode pattern 410-4 on the second plane P2, and an orthogonal projection of the first electrochromic pattern 440-5 on the second plane P2 completely overlaps with an orthogonal projection of the second electrode pattern 410-5 on the second plane P2.

The embodiments of the present disclosure do not limit the overlapping region between the orthogonal projections of the first electrochromic pattern 440 and the second electrode pattern 410 on the second plane P2. The orthogonal projections may completely overlap or partially overlap, that is, the orthogonal projection of the first electrochromic pattern 440 on the second plane P2 and the orthogonal projection of the second electrode pattern 410 on the second plane P2 only partially overlap.

Herein, it will be noted that, since the material of the first electrochromic patterns 440 undergoes the color change reaction in response to the electrons transported between the third electrode layer 41 and the fourth electrode layer 42, in a case where the third electrode layer 41 includes the plurality of second electrode patterns 410 arranged at intervals, only a portion of each first electrochromic pattern 440 that overlaps with the corresponding second electrode pattern 410 undergoes the color change reaction and changes its transmittance to the visible light due to action of the second potential difference.

Based on this, as shown in FIG. 12, the visible light dimming structure 400 further includes a plurality of second barrier walls 47 arranged at intervals. A corresponding second barrier wall 47 of the plurality of second barrier walls 47 is provided between any two adjacent second electrode patterns 410, and the second barrier wall 47 is located between two first electrochromic patterns 440 corresponding to the two adjacent second electrode patterns 410. The second barrier wall 47 may separate the two adjacent second electrode patterns 410 to avoid crosstalk between potentials applied to the two adjacent second electrode patterns 310, and also enables the first electrochromic patterns 440 to be manufactured through a spray coating method, thereby simplifying a manufacturing process of the first electrochromic patterns 440.

For example, as shown in FIG. 12, a second barrier wall 47-1 is provided between the second electrode pattern 410-1 and the second electrode pattern 410-2, that is to say, the second barrier wall 47-1 is located between the second electrode pattern 410-1 and the second electrode pattern 410-2; and the second barrier wall 47-1 is further located between the first electrochromic pattern 440-1 and the first electrochromic pattern 440-2. A second barrier wall 47-2 is provided between the second electrode pattern 410-2 and the second electrode pattern 410-3, that is to say, the second barrier wall 47-2 is located between the second electrode pattern 410-2 and the second electrode pattern 410-3; and the second barrier wall 47-2 is further located between the first electrochromic pattern 440-2 and the first electrochromic pattern 440-3. Positional relationships between remaining first electrochromic patterns (440-4 and 440-5) and remaining second barrier walls (47-3 and 47-4) are similar thereto.

The numbers of the second electrode patterns 440 and the first electrochromic patterns 410 are not limited in the embodiments of the present disclosure, and may be set as needed. It will be understood that, in a case where one second electrode pattern 410 corresponds to one first electrochromic pattern 440, the number of the second electrode patterns 410 is equal to the number of the first electrochromic patterns 440.

For example, as shown in FIG. 11C, the dimming substrate 3 further includes a plurality of electrode lines 411, and each second electrode pattern 410 is individually electrically connected to an electrode line 411. By applying a potential to each second electrode pattern 410 through an individual electrode line, different potentials may be applied to the plurality of second electrode patterns 410.

Based on this, the dimming substrate 3 further includes an insulating layer separating the plurality of second electrode patterns 410 and the plurality of electrode lines 411, that is, the plurality of electrode lines and the plurality of second electrode patterns 410 are located on two opposite sides of the insulating layer, and an electrode pattern 410 and a corresponding electrode line directly contact through a via hole (indicated by the black dot in FIG. 110) provided in the insulating layer, that is, they are electrically connected together to transmit electrical signals. For example, a material of the insulating layer may be an inorganic insulating material, such as silicon nitride, or an organic insulating material, such as PI.

In some embodiments, the visible light dimming structure 400 further includes a second electrochromic layer disposed between the third electrode layer 41 and the fourth electrode layer 42. As shown in FIG. 9C, the second electrochromic layer 45 is disposed on a surface of the second ion storage layer 46 facing away from the first electrochromic layer 44, that is, the second ion transport layer 43 is disposed between the first electrochromic layer 44 and the second electrochromic layer 45. Of course, the second electrochromic layer 45 may also be disposed between the second ion storage layer 46 and the second ion transport layer 43. The embodiments of the present disclosure do not limit a position of the second electrochromic layer 45, as long as it is located between the third electrode layer 41 and the fourth electrode layer 42.

Similar to the first electrochromic layer 44, after the second potential difference is applied between the third electrode layer 41 and the fourth electrode layer 42, the electrons are transported between the third electrode layer 41 and the fourth electrode layer 42, and a material of the second electrochromic layer 45 undergoes a color change reaction, such as an oxidation-reduction reaction, during the transport of the electrons, so that the second electrochromic layer 45 reversibly switches between the second transparent state and a second color rendering state. In addition, in the case where different second potential differences are applied between the third electrode layer 41 and the fourth electrode layer 42, products generated after the color change reaction of the second electrochromic layer 45 are different, so that colors displayed by the second electrochromic layer 45 are different, and a transmittance of the second electrochromic layer 45 to the visible light is changed. In the embodiments of the present disclosure, the second color rendering state is a state that the second electrochromic layer 45 presents after the material thereof undergoes the color change reaction in response to the second potential difference. The second transparent state is a state of the second electrochromic layer 45 before the material thereof undergoes the color change reaction in response to the second potential difference, that is, the visible light dimming structure 400 can transmit most of the visible light in the second transparent state.

It will be noted that, the color change reaction of the material of the second electrochromic layer 45 in the embodiments of the present disclosure is also reversible, that is, when the second potential difference (e.g., 2 V) is applied between the third electrode layer 41 and the fourth electrode layer 42, the material of the second electrochromic layer 45 reacts to present the second color rendering state and adjust its transmittance to the visible light; and under another condition, for example, when the potential difference (e.g., −2 V) opposite to the second potential difference is applied between the third electrode layer 41 and the fourth electrode layer 42, the material of the second electrochromic layer 45 undergoes a reverse reaction, so that the material of the second electrochromic layer 45 may be restored to a substance before it undergoes the color change reaction (i.e., making it in a faded state). Thus, the color change reaction of the material of the second electrochromic layer 45 may be cycled multiple times, so that the dimming substrate 3 may be used continuously.

As a result, in a case where the products generated after the color change reactions of the first electrochromic layer 44 and the second electrochromic layer 45 each have a low transmittance to the visible light, the dimming substrate 3 may achieve a good light shielding effect.

For the material of the second electrochromic layer 45, reference may be made to the illustration of the first electrochromic layer 44, and details will not be repeated herein. The materials of the second insulating layer 45 and the first insulating layer 44 may be the same or different.

It will be noted that, in a case where the visible light dimming structure 400 includes the first electrochromic layer 44 and the second electrochromic layer 45, the function of the second ion storage layer 46 further includes storing and providing ions required for the reversible color change reaction of the second electrochromic layer 45, so that a color reaction process of the second electrochromic layer 45 may be maintained in balance.

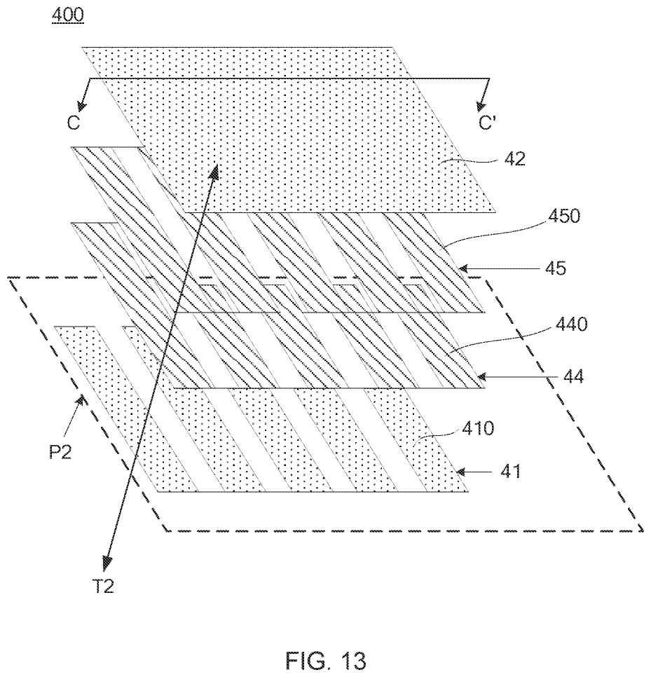

In some embodiments, as shown in FIG. 13, the second electrochromic layer 45 includes a plurality of second electrochromic patterns 450 arranged at intervals, and the third electrode layer 41 includes a plurality of second electrode patterns 410 arranged at intervals. The plurality of second electrochromic patterns 450 are each strip-shaped, and are arranged in a line; correspondingly, the plurality of second electrode patterns 410 are also each strip-shaped, and are also arranged in a line. Of course, the plurality of second electrochromic patterns 450 may also each be block-shaped, for example, the plurality of second electrochromic patterns 450 are arranged in a matrix; correspondingly, the plurality of second electrode patterns 410 may also each be block-shaped. The embodiments of the present disclosure do not limit this.

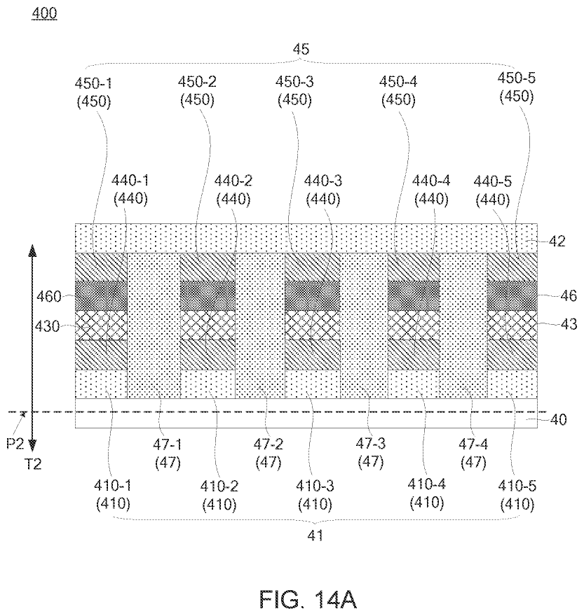

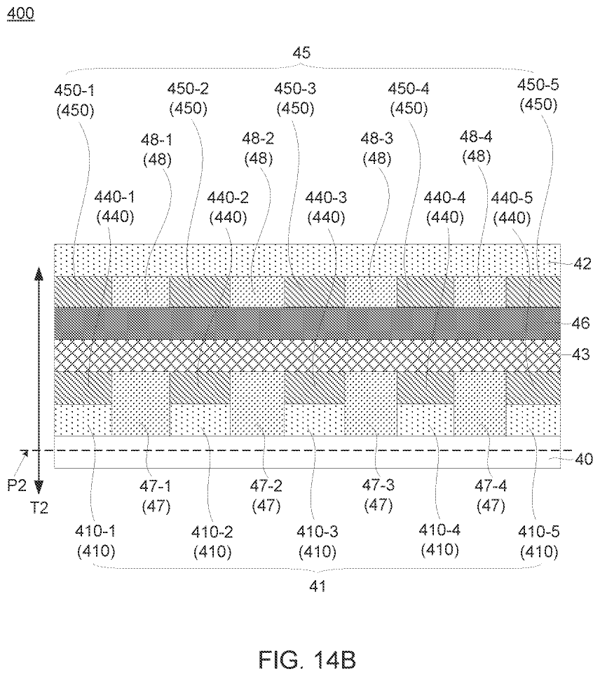

In the embodiments of the present disclosure, as shown in FIGS. 13 and 14A, there is an overlapping region between an orthogonal projection of each second electrochromic pattern 450 on the second plane P2 and an orthogonal projection of a respective one of the plurality of second electrode patterns 410 on the second plane P2. FIG. 14A is a sectional diagram of the visible light dimming structure 400 taken along the line C-C′ in FIG. 13. It will be noted that, in order to illustrate the second electrode patterns 410, the first electrochromic patterns 450 and the second electrochromic patterns 450 more clearly, the second ion storage layer 46 and the second ion transport layer 43 are not shown.

FIG. 14A illustrates only five second electrochromic patterns 450 (450-1, 450-2, 450-3, 450-4, and 450-5) and five corresponding second electrode patterns 410 (410-1, 410-2, 410-3, 410-4, and 410-5), and shows an example in which the orthogonal projection of each second electrochromic pattern 450 on the second plane P2 completely overlaps with the orthogonal projection of the respective one of the plurality of second electrode patterns 410 on the second plane P2. For example, an orthogonal projection of the second electrochromic pattern 450-1 on the second plane P2 completely overlaps with the orthogonal projection of the second electrode pattern 410-1 on the second plane P2, an orthogonal projection of the second electrochromic pattern 450-2 on the second plane P2 completely overlaps with the orthogonal projection of the second electrode pattern 410-2 on the second plane P2, and an orthogonal projection of the second electrochromic pattern 450-3 on the second plane P2 completely overlaps with the orthogonal projection of the second electrode pattern 410-3 on the second plane P2, and positional relationships between remaining second electrochromic patterns (450-4 and 450-5) and remaining second electrode patterns (410-4 and 410-5) are similar thereto.

The embodiments of the present disclosure do not limit the overlapping region between the orthogonal projections of the second electrochromic pattern 450 and the second electrode pattern 410 on the second plane P2. The orthogonal projections may completely overlap or partially overlap, that is, the orthogonal projection of the second electrochromic pattern 450 on the second plane P2 and the orthogonal projection of the second electrode pattern 410 on the second plane P2 only partially overlap.

Herein, it will be noted that, since the material of the second electrochromic patterns 450 undergoes the color change reaction in response to the electrons transported between the third electrode layer 41 and the fourth electrode layer 42, in the case where the third electrode layer 41 includes a plurality of second electrode patterns 410 arranged at intervals, only a portion of each second electrochromic pattern 450 that overlaps with the corresponding second electrode pattern 410 undergoes the color change reaction and changes its transmittance to the visible light due to the action of the second potential difference.

Based on this, as shown in FIG. 14A, the second ion transport layer 43 includes a plurality of second ion transport patterns 430 arranged at intervals, and the second ion storage layer 46 includes a plurality of second on storage patterns 460 arranged at intervals; and there is an overlapping region between an orthogonal projection of each second ion transport pattern 430 on the second plane P2 and an orthogonal projection of a respective second electrode pattern 410 on the second plane P2, and there is an overlapping region between an orthogonal projection of each second ion storage pattern 460 on the second plane P2 and an orthogonal projection of a respective second electrode pattern 410 on the second plane P2. In this case, the second barrier wall 47 provided between any two adjacent second electrode patterns 410 is further located between two second ion transport patterns 430, between two second ion storage patterns 460 and between two second electrochromic patterns 450 that correspond to the two adjacent second electrode patterns 410.

For example, as shown in FIG. 14A, the second barrier wall 47-1 is provided between the second electrode pattern 410-1 and the second electrode pattern 410-2, that is to say, the second barrier wall 47-1 is located between the second electrode pattern 410-1 and the second electrode pattern 410-2; and the second barrier wall 47-1 is further located between two second ion transport patterns 430, between two second ion storage patterns 460, and between two second electrochromic patterns (450-1 and 450-2) that correspond to the two adjacent second electrode patterns (410-1 and 410-2). The second barrier wall 47-2 is provided between the second electrode pattern 410-2 and the second electrode pattern 410-3, that is to say, the second barrier wall 47-2 is located between the second electrode pattern 410-2 and the second electrode pattern 410-3; and the second barrier wall 47-2 is further located between two second ion transport patterns 430, between two second ion storage patterns 460, and between two second electrochromic patterns (450-2 and 450-3) that correspond to the two adjacent second electrode patterns (410-2 and 410-3).

The number of the second electrode patterns 450 is not limited in the embodiments of the present disclosure, and may be set as needed. It will be understood that, in a case where one second electrode pattern 410 corresponds to one second electrochromic pattern 450, the number of the second electrochromic patterns 450 is equal to the number of the second electrode patterns 410.

In some other embodiments, as shown in FIG. 14B, the second ion transport layer 43 and the second ion storage layer 46 are each a whole layer. In this case, the visible light dimming structure 400 further includes a plurality of third barrier walls 48 arranged at intervals, and a respective one of the plurality of third barrier walls 48 is provided between any two adjacent second electrochromic patterns 450. The third barrier walls 48 enable the second electrochromic patterns 450 to be manufactured through a spray coating method, thereby simplifying a manufacturing process of the second electrochromic patterns 450. For example, as shown in FIG. 14B, a third barrier wall 48-1 is provided between two adjacent second electrochromic patterns (450-1 and 450-2), and a third barrier wall 48-2 is provided between two adjacent second electrochromic patterns (450-2 and 450-3). Positional relationships between remaining second electrochromic patterns (450-4 and 450-5) and remaining third barrier walls (48-3 and 48-4) are similar thereto.

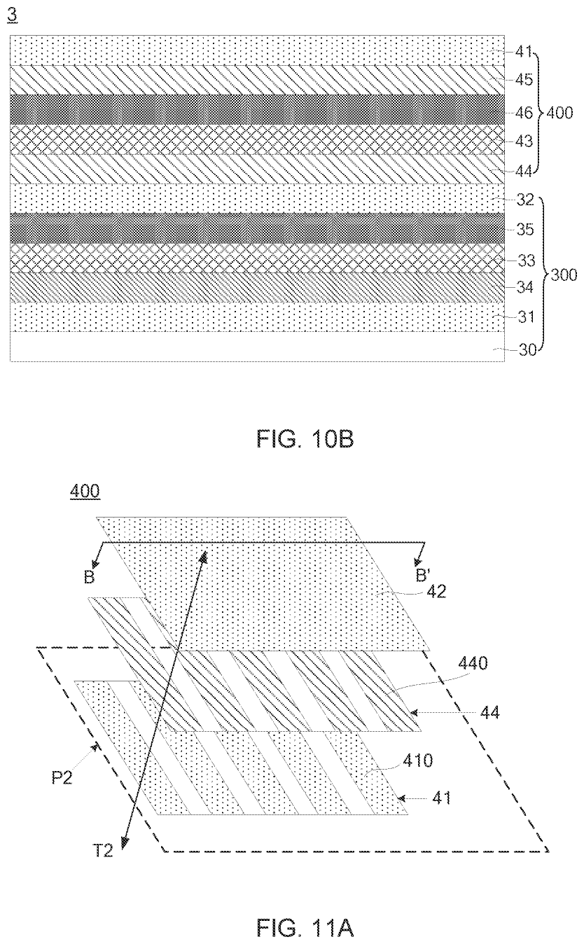

In some embodiments, as shown in FIG. 10A, the visible light dimming structure 400 includes the third electrode layer 41 and the first electrochromic layer 44. The first electrochromic layer 44 is disposed between the third electrode layer 41 and the infrared light dimming structure 300.

For example, as shown in FIG. 10A, the second electrode layer 32 in the infrared light dimming structure 300 is closer to the visible light dimming structure 400 than the first electrode layer 31, and the first electrochromic layer 44 is disposed between the third electrode layer 41 and the second electrode layer 32. In this case, the second electrode layer 32 is a common electrode layer of the infrared light dimming structure 300 and the visible light dimming structure 400. Based on this, the first electrochromic layer 44 is configured to be reversibly switchable between the first transparent state and the first color rendering state in response to the second potential difference applied between the third electrode layer 41 and the second electrode layer 32.

For another example, the first electrode layer 31 in the infrared light dimming structure 300 is closer to the visible light dimming structure 400 than the second electrode layer 32, and the first electrochromic layer 44 is disposed between the third electrode layer 41 and the first electrode layer 31. In this case, the first electrode layer 31 is a common electrode layer of the infrared light dimming structure 300 and the visible light dimming structure 400. Based on this, the first electrochromic layer 44 is configured to be reversibly switchable between the first transparent state and the first color rendering state in response to the second potential difference applied between the third electrode layer 41 and the first electrode layer 31.

In the embodiments of the present disclosure, the first electrode layer 31 or the second electrode layer 32 may serve as a common electrode layer of the infrared light dimming structure 300 and the visible light dimming structure 400, which may simplify the structure of the dimming substrate 3. After a constant potential (e.g., 0 V) is applied to the first electrode layer 31 (or the second electrode layer 32), and then potentials are applied to the second electrode layer 32 (or the first electrode layer 31) and the third electrode layer 41, the first potential difference may be formed between the first electrode layer 31 and the second electrode layer 32, and the second potential difference may be formed between the first electrode layer 31 (or the second electrode layer 32) and the third electrode layer 41. In this way, the infrared light dimming structure 300 and the visible light dimming structure 400 may be controlled simultaneously.

In some examples, the common electrode layer (e.g., the first electrode layer 31 or the second electrode layer 32) of the infrared light dimming structure 300 and the visible light dimming structure 400 is a whole electrode layer. This facilitates to apply a constant potential to the common electrode layer.

In some embodiments, as shown in FIG. 10B, similar to that the visible light dimming structure 400 includes two electrode layers (i.e., the third electrode layer 41 and the fourth electrode layer 42), as shown in FIG. 10B, in a case where only the third electrode 41 is provided in the visible light dimming structure 400, and no other electrode layer is involved (i.e., the first electrode layer 31 or the second electrode layer 32 may serve as the common electrode layer of the infrared light dimming structure 300 and the visible light dimming structure 400), the visible light dimming structure 400 further includes the second ion transport layer 43 and the second ion storage layer 46 disposed between the third electrode layer 41 and the infrared light dimming structure 300, the second ion storage layer 46 and the second ion transport layer 43 are stacked, and the second ion storage layer 46 is in direct contact with at least the second ion transport layer 43. For the positional relationship between the second ion storage layer 46 and the second ion transport layer 43 in the visible light dimming structure 400, reference may be made to the illustration in the above embodiments, and details will not be repeated herein. FIG. 10B shows an example in which the second ion transport layer 43 is disposed closer to the first electrochromic layer 44 than the second ion storage layer 46.

In some other embodiments, the visible light dimming structure 400 further includes the second electrochromic layer 45 disposed between the third electrode layer 41 and the infrared light dimming structure 300, and the second electrochromic layer 45 is configured to be reversibly switchable between the second transparent state and the second color rendering state in response to the second potential difference applied between the third electrode layer 41 and the first electrode layer 31 (or the second electrode layer 32). For the position of the second electrochromic layer 45 in the visible light dimming structure 400, reference may be made to the illustration in the above embodiments, and details will not be repeated herein. FIG. 103 shows an example in which the second electrochromic layer 45 is disposed on the surface of the second ion storage layer 46 facing away from the first electrochromic layer 44, that is, the second ion transport layer 43 is disposed between the first electrochromic layer 44 and the second electrochromic layer 45.

In the dimming glass 100 provided in the above embodiments, for example, the first transparent sheet 1 is an outer glass, i.e., a glass proximate to an outdoor space, and the second transparent sheet 2 is an inner glass, i.e., a glass proximate to an indoor space.

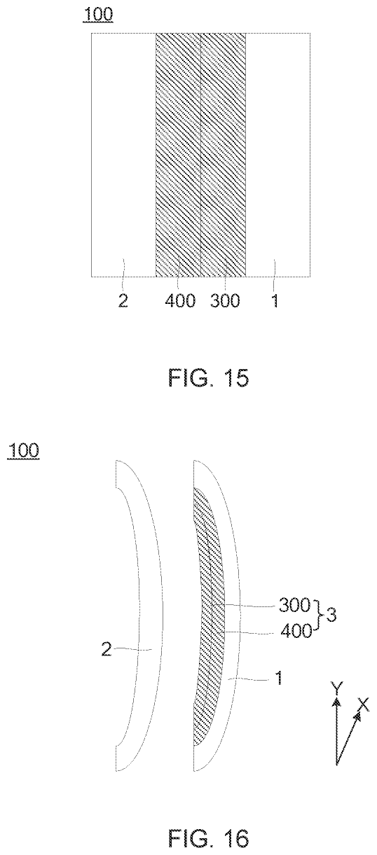

Based on this, in a case where the dimming substrate 3 includes the infrared light dimming structure 300 and the visible light dimming structure 400, for example, as shown in FIG. 15, the infrared light dimming structure 300 is closer to the outer glass 1 than the visible light dimming structure 400. For another example, as shown in FIG. 16, the infrared light dimming structure 300 is farther away from the outer glass 1 than the visible light dimming structure 400.

In some embodiments, the visible light dimming structure 400 further includes a third base disposed farther away from the infrared light dimming structure 300.

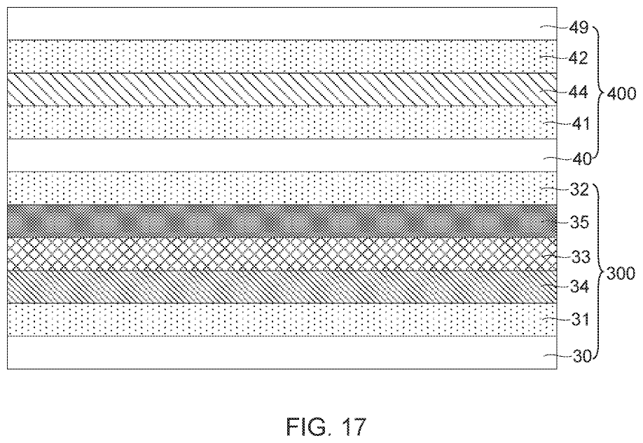

For example, as shown in FIG. 17, in a case where the visible light dimming structure 400 includes the third electrode layer 41 and the fourth electrode layer 42, and the fourth electrode layer 42 is farther away from the infrared light dimming structure 300 than the third electrode layer 41, the third base 49 is disposed on a surface of the fourth electrode layer 42 facing away from the infrared light dimming structure 300. For another example, in the case where only the third electrode layer 41 is provided in the visible light dimming structure 400, and no other electrode layer is involved (i.e., the first electrode layer 31 or the second electrode layer 32 may serve as the common electrode layer of the infrared light dimming structure 300 and the visible light dimming structure 400), the third base 49 is disposed on a side of the third electrode layer 41 away from the infrared light dimming structure 300. That is, the third base 49 may be connected to the first transparent sheet 1 of the dimming glass 100. Alternatively, in some other embodiments, the first transparent sheet 1 may serve as a base for supporting the layers of the dimming substrate 3 shown in FIG. 17, and at least some of the layers in the dimming substrate 3 may be sequentially formed on the first transparent sheet 1.

For example, a material of the third base 49 may be the same as or different from the material of the first base 30 or the material of the second base 40.

In the following embodiments, two methods for manufacturing the dimming substrate 3 are provided by taking an example in which the dimming substrate 3 includes the infrared light dimming structure 300 and the visible light dimming structure 400, the visible light dimming structure 400 includes the third electrode layer 41 and the fourth electrode layer 42, and the materials of the first electrode layer 31, the second electrode layer 32, the third electrode layer 41 and the fourth electrode layer 42 are all ITO.

In some embodiments, in a case where the dimming substrate 3 needs to perform full-surface dimming, that is, the first electrode layer 31, the second electrode layer 32, the third electrode layer 41, and the fourth electrode layer 42 are each a whole transparent electrode layer, and the electro-dimming layer 34, the first electrochromic layer 44 and the second electrochromic layer 45 are each a whole layer, the method for manufacturing the dimming substrate 3 includes step 1 (S1) to step 12 (S12).

In S1, an ITO film is formed on the first base 30 by using a process such as magnetron sputtering to obtain the first electrode layer 31.

In S2, the first electrode layer 31 serving as a working electrode, an auxiliary electrode (e.g., another ITO film), and a reference electrode (e.g., a wire-like silver electrode) are soaked into a solution of monomer 3,4-(2,2-dimethyl-propylenedioxy) thiophene, and the monomer is polymerized to form a polymer on the first electrode layer 31 by using cyclic voltammetry at a potential within a range of −1.2 v to 1.2 v inclusive, thereby forming the electro-dimming layer 34.

In S3, the material of the first ion transport layer is spin-coated or scrape-coated on the electro-dimming layer 34 to form the first ion transport layer 33.

In S4, the material of the first ion storage layer is spin-coated or scrape-coated on the first ion transport layer 33 to form the first ion storage layer 35.

In S5, an ITO film (i.e., the second electrode layer 32) is formed on the first ion storage layer 35 by using a process such as magnetron sputtering to form the infrared light dimming structure 300.

In S6, an ITO film is formed on the second base 40 by using a process such as magnetron sputtering to obtain the third electrode layer 41.

In S7, the material of the first electrochromic layer 44 is spin-coated or scrape-coated on the third electrode layer 41 to form the first electrochromic layer 44.

For example, a viscosity of the material of the first electrochromic layer 44 is less than or equal to 100 cp, and a spin coating speed is in a range of 300 rpm to 1000 rpm inclusive. The third electrode layer 41 coated with the material of the first electrochromic layer 44 is dried to cure the material in a fluid state to form the first electrochromic layer 44, at a temperature controlled, for example, in a range of 100° C. to 150° C. inclusive, for a time, for example, in a range of 10 mins to 1 h inclusive.

In S8, the material of the second ion transport layer 43 is spin-coated or scrape-coated on the first electrochromic layer 44 to form the second ion transport layer 43.

In S9, the material of the second ion storage layer 46 is spin-coated or scrape-coated on the first ion transport layer 43 to form the first ion storage layer 46.

In S10, the second electrochromic layer 45 is formed on the second ion storage layer 46.

For a method of forming the second electrochromic layer 45, reference may be made to the method of forming the first electrochromic layer 44, and details will not be repeated herein.

In S11, an ITO film is formed on the second electrochromic layer 45 to obtain the fourth electrode layer 42, thereby forming the visible light dimming structure 400.

In S12, a frame sealant is coated on a periphery of the infrared light dimming structure 300 or the visible light dimming structure 400, and the infrared light dimming structure 300 and the visible light dimming structure 400 are adhered together to obtain the dimming substrate 3.

In some examples, the material of the second ion transport layer 43 is a liquid material. In this case, the first electrochromic layer 44 and the second electrochromic layer 45 are formed individually.

For example, a method for manufacturing the visible light dimming structure 400 is as follows.

The third electrode layer 41 and the first electrochromic layer 44 are formed on the second base 40; then the material of the second ion transport layer 43, such as an electrolyte solution, is dripped on a surface of the first electrochromic layer 44; and then the first electrochromic layer 44 with the material of the second ion transport layer 43 is placed at a temperature in a range of 200° C. to 400° C. inclusive for a time in a range of 5 mins to 10 mins inclusive, and a solvent in the electrolyte solution is volatilized to change the electrolyte from a liquid state to a gel state, so that the second ion transport layer 43 is obtained. In this case, for convenience of description, a structure including the second base 40, the third electrode layer 41, the first electrochromic layer 44, and the second ion transport layer 43 may be referred to as a first electrochromic substrate.

The fourth electrode layer 42 and the second electrochromic layer 45 are formed on the third base 49; and then the material of the second ion storage layer 46 is spin-coated on the second electrochromic layer 45 to form the second ion storage layer 46. In this case, for convenience of description, a structure including the third base 49, the fourth electrode layer 42, the second electrochrornic layer 45, and the second ion transport layer 46 may be referred to as a second electrochromic substrate.

Thereafter, a frame sealant is coated on a periphery of the first electrochromic substrate or the second electrochromic substrate, and then the first electrochromic substrate and the second electrochromic substrate are adhered to each other under a vacuum condition. Then, the first electrochromic substrate and the second electrochromic substrate that are assembled together are placed at a temperature in a range of 110° C. to 130° C. inclusive for a time in a range of 30 mins to 40 mins inclusive to cure the frame sealant adhering the first electrochromic substrate to the second electrochromic substrate, so that the visible light dimming structure 400 is obtained.

In some other embodiments, in a case where the visible light dimming structure 400 needs to perform a partitioned adjustment of the transmittance of the visible light, and/or display of simple characters, for example, as shown in FIG. 13, the third electrode layer 41 includes a plurality of second electrode patterns 410, the fourth electrode layer 42 is a whole electrode layer, the first electrochromic layer 44 includes a plurality of first electrochromic patterns 440, the second electrochromic layer 45 includes a plurality of second electrochromic patterns 450, the second ion transport layer 43 includes a plurality of second ion transport patterns 430, and the second ion storage layer 46 includes a plurality of second ion storage patterns 460, the method for manufacturing the visible light dimming structure 400 includes the following steps.

An entire ITO film is coated on the second base 30, and the entire ITO film is etched to form the strip-shaped second electrode patterns 410 shown in FIG. 11A, or form the block-shaped second electrode patterns 410 shown in FIG. 11B, so that the third electrode layer 41 is obtained.

For example, the entire ITO film may be etched by using laser light. A wavelength of the laser light may be, for example, in a range of 200 nm to 400 nm inclusive. In a case where the second electrode patterns 410 are in the stripe shape shown in FIG. 11A, a distance between two adjacent second electrode patterns 410 may be, for example, greater than or equal to 40 pm; and in a case where the second electrode patterns 410 are in the block shape shown in FIG. 11B, a minimum distance between two adjacent second electrode patterns 410 may be, for example, in a range of 2 μm to 3 μm inclusive.

For another example, the entire ITO film may also be etched by using a patterning process. Herein, the patterning process may include: coating a photoresist on a surface of a film (e.g., the above ITO film) to be patterned, exposing the coated photoresist, developing the exposed photoresist to expose a partial region of the film, etching (e.g., a wet etching process may be adopted) the exposed region of the film to remove a portion of the film in the region, and removing the photoresist to expose a patterned portion of the film. It will be noted that, a patterned structure formed through the patterning process may be continuous or discontinuous, and portions of the patterned structure may be at different heights, and may have different thicknesses.

A plurality of second barrier walls 47 are formed, and a material of the second barrier walls 47 is, for example, resin or PI That is, a layer of resin or PI is coated on a surface of the third electrode layer 41 facing away from the second base 40, and then is etched by using a patterning process to form the plurality of second barrier walls 47 arranged at intervals, so that a second barrier wall 47 is provided between two adjacent second electrode patterns 410.

Then, the material of the first electrochromic layer 44 is sprayed on surfaces of the second electrode patterns 410 to form the plurality of first electrochromic patterns 440; then the material of the second ion transport layer 43 and the material of the second ion storage layer 46 are sequentially spin-coated or scrape-coated on surfaces of the first electrochromic patterns 410 to respectively form the plurality of second ion transport patterns 430 and the plurality of second ion storage patterns 460; and then the material of the second electrochromic layer 45 is sprayed on surfaces of the second ion storage patterns 460 to form the plurality of second electrochromic patterns 450.

For example, the material of the first electrochromic layer 44 is a solution with a viscosity less than or equal to 15 cp, which may be sprayed on the surfaces of the second electrode patterns 410 by using an air compressor.

For another example, the material of the second electrochromic layer 45 is a solution with a viscosity less than or equal to 15 cp, which may be sprayed on surfaces of the second ion storage patterns 460 by using an air compressor.

In yet some other embodiments, in a case where the infrared light dimming structure 300 needs to perform a partitioned adjustment of the reflectivity of the infrared light, for example, as shown in FIG. 7, the first electrode layer 31 includes a plurality of first electrode patterns 310, the second electrode layer 32 is a whole electrode layer, the electro-dimming layer 34 includes a plurality of electro-dimrning patterns 340, and the first ion transport layer 33 and the first ion storage layer 35 are each a whole layer, a method for manufacturing the infrared light dimming structure is as follows.

An ITO film is formed on the first base 30 by using a magnetron sputtering method, and then the ITO film is etched to obtain the first electrode layer 31 including the plurality of first electrode patterns 310; and then the plurality of first barrier walls 36 arranged at intervals are formed, so that a first barrier wall 36 is provided between any two adjacent first electrode patterns 310. Then the first base 30 on which the plurality of first electrode patterns 310 and the plurality of first barrier walls 36 have been formed is soaked in the solution of the monomer 3,4-(2,2-dimethyl-propylenedioxy) thiophene, the first electrode layer 31 serving as the working electrode, the auxiliary electrode, and the reference electrode (e.g., the wire-like silver electrode) are soaked in the solution of the monomer, and the monomer is polymerized to form the polymer on the first electrode layer 31 by using the cyclic voltammetry at the potential within the range of −1.2 v to 1.2 v inclusive, thereby forming the electro-dimming patterns 340 on the surfaces of the first electrode patterns 310 to obtain the electro-dimming layer 34. Herein, for a method for forming the first barrier walls 36, reference may be made to the method for forming the second barrier walls 47 described above, and conditions for the polymerization of the monomer 3,4-(2,2-dimethyl-propylenedioxy) thiophene are the same as those in the above embodiments, and methods for forming the first ion transport layer 33, the first ion storage layer 35, and the second electrode layer 32 are the same as those provided in the above embodiments, and details will not be repeated herein.

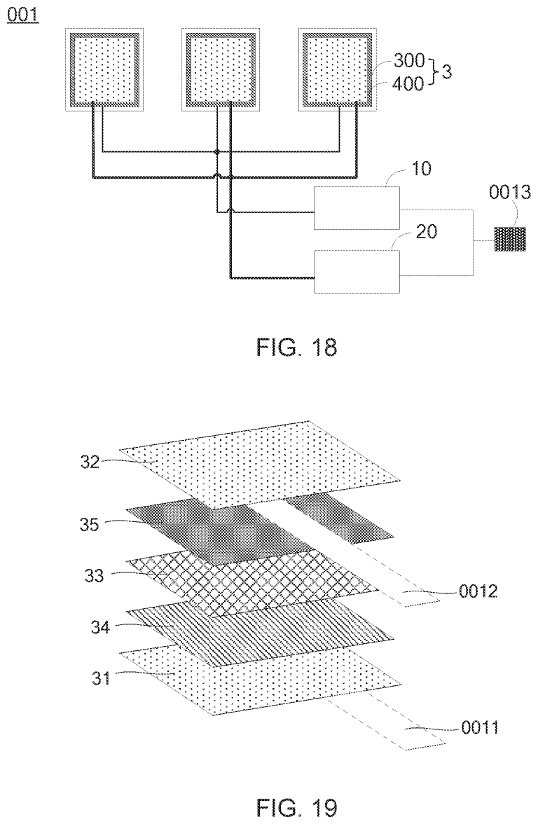

Some embodiments of the present disclosure provide a light transmittance adjusting system. As shown in FIG. 18, the light transmittance adjusting system 001 includes a first voltage supply device 10 and at least one dimming substrate 3 each provided by any one of the above embodiments. The first voltage supply device 10 is electrically connected to the first electrode layer 31 and the second electrode layer 32 in the infrared light dimming structure 300, and is configured to apply the first potential difference between the first electrode layer 31 and the second electrode layer 32. FIG. 18 shows an example in which the first voltage supply device 10 is electrically connected to three dimming substrates 3. The first voltage supply device 10 may also be electrically connected to only one dimming substrate 3, that is, the light transmittance adjusting system 001 includes one dimming substrate 3, which is not limited in the embodiments of the present disclosure.

As shown in FIG. 18, the first voltage supply device 10 is further electrically connected to a power supply 0013. The first voltage supply device 10 may convert a power supply voltage into a voltage required by the infrared light dimming structure 300 (i.e., the first potential difference between the first electrode layer 31 and the second electrode layer 32). For example, in a case where the power supply voltage is at 220 V, 110 V, or 12 V, the first voltage supply device 10 may convert the power supply voltage to any one of voltage values in a range of −1.5 V to 0 V inclusive, i.e., the first potential difference applied between the first electrode layer 31 and the second electrode layer 32.

For example, the first voltage supply device 10 is a power adapter. The embodiments of the present disclosure do not limit a structure of the first voltage supply device 10, as long as the first voltage supply device 10 is able to convert the power supply voltage into the first potential difference required by the infrared light dimming structure 300, and apply the first potential difference between the first electrode layer 31 and the second electrode layer 32 in the infrared light dimming structure 300.

In some examples, the first voltage supply device 10 may be electrically connected to the first electrode layer 31 and the second electrode layer 32 through flexible printed circuits (FPCs). Of course, the first voltage supply device 10 may also be electrically connected to the first electrode layer 31 and the second electrode layer 32 through connecting wires, which is not limited in the embodiments of the present disclosure, as long as the first voltage supply device 10 is able to apply the first potential difference between the first electrode layer 31 and the second electrode layer 32.

For example, as shown in FIG. 19, the light transmittance adjusting system 001 further includes a first FPC 0011 and a second FPC 0012. The first FPC 0011 is bonded to the first electrode layer 31, and the second FPC 0012 is bonded to the second electrode layer 32. In addition, the first FPC 0011 and the second FPC 0012 are electrically connected to the first voltage supply device 10. In this way, after the first voltage supply device 10 applies the first potential difference between the first electrode layer 31 and the second electrode layer 32, the internal structure of the infrared light dimming structure 300 forms a loop, so that the reflectivity of the infrared light dimming structure 300 to the infrared light is changed by adjusting a magnitude of the first potential difference.

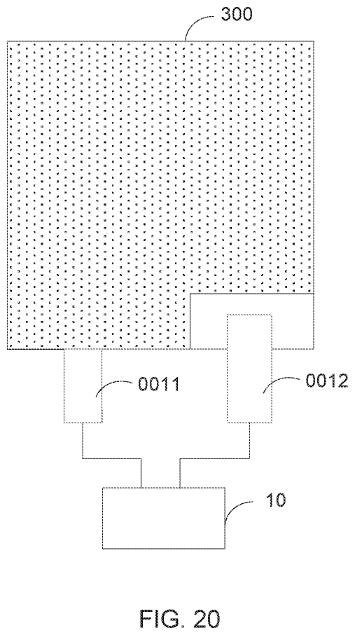

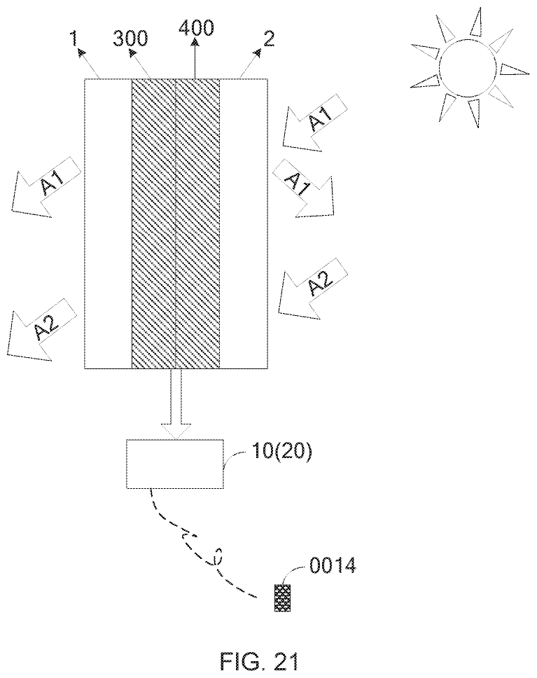

As shown in FIG. 20, the first voltage supply device 10 may be electrically connected to the first FPC 0011 bonded to the first electrode layer 31 and the second FPC0012 bonded to the second electrode layer 32 through two ports in the first voltage supply device 10. Of course, the first voltage supply device 10 may also be electrically connected to the first FPC 0011 and the second FPC 0012 through one port, which is not limited in the embodiments of the present disclosure, as long as the first FPC 0011 and the second FPC 0012 are independent of each other and are not electrically connected.

For example, an edge of the first electrode layer 31 is provided with bonding pins (generally made of a gold material and in a circular shape), and the first FPC 0011 is bonded to the first electrode layer 31 through the bonding pins. For example, a conductive adhesive (e.g., anisotropic conductive film (ACF)) may be provided on the bonding pins, and the first FPC 0011 is placed on the conductive adhesive, and then they are pressed together with a pressure head, so that the first FPC 0011 and the bonding pins are bonded together and electrically connected through the conductive adhesive, thereby achieving the bonding of the first FPC 0011 to the first electrode layer 31.

For example, a diameter of the bonding pins is greater than or equal to 20 μm, and a thickness thereof is greater than or equal to 20 μm; and a pressing temperature is in a range of 200° C. to 300° C. inclusive, a pressure is in a range of 2 Kgf to 5 Kgf inclusive, and a pressing time is in a range of 10 s to 20 s inclusive.

A method for bonding the second FPC 0012 to the second electrode layer 32 is the same as the above method, and details will not be repeated herein.

In some embodiments, the dimming substrate 3 includes the infrared light dimming structure 300 and the visible light dimming structure 400, and the visible light dimming structure 400 includes the third electrode layer 41 and the fourth electrode layer 42. In this case, as shown in FIG. 18, the light transmittance adjusting system 001 further includes a second voltage supply device 20. The second voltage supply device 20 is electrically connected to the third electrode layer 41 and the fourth electrode layer 42, and is configured to apply the second potential difference between the third electrode layer 41 and the fourth electrode layer 42.

As shown in FIG. 18, the second voltage supply device 20 is further electrically connected to the power supply 0013. The second voltage supply device 20 may convert the power supply voltage into a voltage required by the visible light dimming structure 400 (i.e., the second potential difference between the third electrode layer 41 and the fourth electrode layer 42). For example, in the case where the power supply voltage is at 220 V, 110 V, or 12 V, the second voltage supply device 20 may convert the power supply voltage to any one of voltage values in a range of 2 V to 4 V inclusive, i.e., the second potential difference applied between the third electrode layer 41 and the fourth electrode layer 42.

For example, the second voltage supply device 20 is a power adapter. The embodiments of the present disclosure do not limit a structure of the second voltage supply device 20, as long as the second voltage supply device 20 is able to convert the power supply voltage into the second potential difference required by the visible light dimming structure 400, and apply the second potential difference between the third electrode layer 41 and the fourth electrode layer 42 in the visible light dimming structure 400.

For a manner in which the second voltage supply device 20 is electrically connected to the third electrode layer 41 and the fourth electrode layer 42, reference may be made to the manner in which the first voltage supply device 10 is electrically connected to the first electrode layer 31 and the second electrode layer 32 in the above embodiments, and details will not be repeated herein. Of course, the second voltage supply device 20 may also be electrically connected to the third electrode layer 41 and the fourth electrode layer 42 in other manners, for example, the second voltage supply device 20 is electrically connected to the third electrode layer 41 and the fourth electrode layer 42 through connecting wires, which is not limited in the embodiments of the present disclosure, as long as the second voltage supply device 20 is able to apply the second potential difference between the third electrode layer 41 and the fourth electrode layer 42.

In some embodiments, the dimming substrate 3 includes the infrared light dimming structure 300 and the visible light dimming structure 400, and the visible light dimming structure 400 includes only one electrode layer, that is, as shown in FIGS. 10A and 10B, the visible light dimming structure 400 includes the third electrode layer 41, and the second electrode layer 32 in the infrared light dimming structure 300 is the common electrode layer of the infrared light dimming structure 300 and the visible light dimming structure 400. Based on this, the first voltage supply device 10 is electrically connected to the first electrode layer 31 and the second electrode layer 32, and the second voltage supply device 20 is electrically connected to the third electrode layer 41 and the second electrode layer 32, so that the first voltage supply device 10 and the second voltage supply device 20 may apply same potentials to the second electrode layer 32, thereby applying the first potential difference between the first electrode layer 31 and the second electrode layer 32, and applying the second potential difference between the second electrode layer 32 and the third electrode layer 41. Or, it may also be arranged in such a way that the first voltage supply device 10 is electrically connected to the first electrode layer 31 and the second electrode layer 32, and the second voltage supply device 20 is electrically connected to the third electrode layer 41.

In some embodiments, the light transmittance adjusting system 001 may further include a controller configured to control turning off and on of the first voltage supply device 10 and the second voltage supply device 20. The controller may be, for example, a switch, a remote control, a mobile phone, or a portable access device (PAD, e.g., tablet computer). There may be a wired or wireless communication connection between the controller and both the first voltage supply device 10 and the second voltage supply device 20, which is not limited in the embodiment of the present disclosure.

For example, an application (APP) may be designed on the mobile phone, through which intellectualization of the turning off and on of the first voltage supply device 10 and the second voltage supply device 20 may be achieved, and the magnitudes of the voltages supplied by the first voltage supply device 10 and the second voltage supply device 20 may be adjusted, so that the reflectivity of the dimming substrate 3 to the infrared light and the transmittance of the dimming substrate 3 to the visible light may be changed.

In some embodiments, the dimming glass 100 may be applied to windows of buildings, such as office buildings, shopping malls, residential quarters and hospitals.

In some examples, the dimming glass 100 including the infrared light dimming structure 300 and the visible light dimming structure 400 may be applied to a window of a conference room of an office building. For example, when meeting contents need to be projected at a meeting in an office, the visible light dimming structure 400 may be turned on to darken an environment in the office, which facilitates persons at the meeting to see the projected meeting contents clearly and facilitates to protect concealment of a meeting process. In addition, when the transmittance of the visible light dimming structure 400 to the visible light is minimized, the dimming glass 100 may also replace a conventional screen for projection. Herein, turning on the visible light dimming structure 400 is applying the second potential difference to the visible light dimming structure 400 by the second voltage supply device 20 (e.g., turning on the second voltage supply device 20 through the APP), so that the visible light dimming structure 400 changes its transmittance to the visible light in response to the second potential difference.

For example, in summer, a working region in the office needs to be cooled and an indoor brightness needs to be good, in this case, the infrared light dimming structure 300 may be turned on, and the visible light dimming structure 400 is turned off, so that the visible light in an external environment enters an interior of the office to increase the indoor brightness, and the infrared light is reflected to achieve a cooling effect. Herein, turning on the infrared light dimming structure 300 is applying the first potential difference to the infrared light dimming structure 300 by the first voltage supply device 10 (e.g., turning on the first voltage supply device 10 through the APP), so that the infrared light dimming structure 300 changes its reflectivity to the infrared light in response to the first potential difference.

For example, in the office, a part of a region needs to be used for meeting, and the other part of the region needs to be used for office. In this case, the visible light dimming structure 400 may be turned on in the region that needs to be used for meeting, so as to achieve a purpose of adjusting the transmittance of the visible light, reduce a brightness in the region, and protect the concealment of the meeting; and the visible light dimming structure 400 is turned off in the region that needs to be used for office, so that the visible light passes through glass and enters the region, thereby increasing a brightness in the region, and facilitating to create a good office environment for office staff.

In some other examples, in a case where some simple characters (e.g., “WELCOME”, and “PLEASE CLOSE THE DOOR”) need to be displayed on a store window, the store window may adopt the dimming glass 100 including the visible light dimming structure 400 shown in FIG. 11B. By controlling the second voltage supply device 20 to turn on the visible light dimming structure 400 and applying different potentials to different second electrode patterns 410, the products generated after the color change reaction of the material of different first electrochromic patterns 440 are different, so that transmittances of the products to the visible light are different, and the display of the simple characters is achieved.

In yet some other examples, the dimming glass 100 is applied to a bay window of a residential quarter, as shown in FIG. 21, directions indicated by the arrows Al in the figure refer to transmission directions of the infrared light, and directions indicated by the arrows A2 refers to transmission directions of the visible light. In summer, the infrared light dimming structure 300 and the visible light dimming structure 400 may be simultaneously turned on (e.g., the turning on and off of the infrared light dimming structure 300 and the visible light dimming structure 400 may be controlled by the controller 0014), for example, the reflectivity of the dimming glass 100 to the infrared light is made to reach 90%, and only 10% of the infrared light passes through the dimming glass 100, and a small amount of visible light is made to pass through the dimming glass 100 and enter the room, so that the indoor temperature is reduced and the cooling effect is achieved; and in winter, the infrared light dimming structure 300 and the visible light dimming structure 400 may be simultaneously turned off, for example, the reflectivity of the dimming glass 100 to the infrared light is reduced to 20%, that is, the transmittance of the dimming glass 100 to the infrared light is made to reach 80%, and most of visible light is made to pass through the dimming glass 100 and enter the room, so that the room is made warm and the effect of keeping warm is achieved.

In some embodiments, the dimming glass 100 may be applied to a vehicle, and for a specific working principle, reference may be made to the above embodiments, and details will not be repeated herein.

For example, since a driver needs to clearly see road conditions during driving, there is no need to provide visible light dimming structures 400 in a front windshield and glasses at a driver's side and a co-driver's side of a vehicle such as an automobile, and infrared light dimming structures 300 and visible light dimming structures 400 may be provided in glasses at both sides of rear seats of the automobile. During driving of the automobile, the infrared light dimming structures 300 and the visible light dimming structures 400 in the glasses at both sides of the rear seats of the automobile may be controlled to be turned on or off, so as to achieve a purpose of adjusting the reflectivity of the infrared light and the purpose of adjusting the transmittance of the visible light, and in turn achieve purposes of protecting privacy and controlling light. For example, as shown in FIG. 21, in summer, regardless of whether the automobile is in a driving state or a stopped state, the infrared light dimming structures 300 may be turned on to make reflectivities of the window glasses to the infrared light large, so as to make an interior of the automobile cool; and in winter, the infrared light dimming structures 300 may be turned off to make the reflectivities of the window glasses to the infrared light small, i.e., to make transmittances of the window glasses to the infrared light large, so as to make the interior of the automobile warm.

For example, glasses used in windows of a vehicle are flexible glass sheets. As shown in FIGS. 2B, 3A and 16, the first transparent sheet 1 and the second transparent sheet 2 are both flexible glass sheets. The windows of the vehicle (e.g., the automobile) are hollow dimming glasses 100 with double layers and double curvatures (a radius of curvature in the X direction being greater than 1800 mm, and a radius of curvature in the Y direction being greater than 2000 mm). For another example, as shown in FIG. 2B, the windows of the vehicle (e.g., the automobile) are dimming glasses 100 with a single layer and double curvatures (the curvatures being the same as above).

The foregoing descriptions are merely specific implementations of the present disclosure, but the protection scope of the present disclosure is not limited thereto. Any changes or replacements that a person skilled in the art could conceive of within the technical scope of the present disclosure shall be included in the protection scope of the present disclosure. Therefore, the protection scope of the present disclosure shall be subject to the protection scope of the claims.

What is claimed is:

1. A dimming substrate, comprising:
an infrared light dimming structure, the infrared light dimming structure including:
a first electrode layer;
a second electrode layer disposed opposite to the first electrode layer; and
an electro-dimming layer disposed between the first electrode layer and the second electrode layer, the electro-dimming layer being configured such that a reflectivity of the electro-dimming layer to infrared light is changeable in response to a first potential difference applied between the first electrode layer and the second electrode layer.

2. The dimming substrate according to claim 1, wherein a material of the electro-dimming layer includes a polymer, and a monomer of the polymer is 3,4-(2,2-dimethyl-propylenedioxy) thiophene.

3. The dimming substrate according to claim 1, wherein the infrared light dimming structure further includes:
a first ion transport layer disposed between the first electrode layer and the second electrode layer, and stacked with the electro-dimming layer; and
a first ion storage layer disposed between the first electrode layer and the second electrode layer, and stacked with the first ion transport layer, the first ion storage layer being in direct contact with at least the first ion transport layer.

4. The dimming substrate according to claim 1, wherein
the first electrode layer or the second electrode layer includes a plurality of first electrode patterns arranged at intervals;
the electro-dimming layer includes a plurality of electro-dimming patterns arranged at intervals, and an orthogonal projection of each electro-dimming pattern on a first plane perpendicular to a thickness direction of the infrared light dimming structure and an orthogonal projection of a respective one of the plurality of first electrode patterns on the first plane have an overlapping region therebetween; and
the infrared light dimming structure further includes a plurality of first barrier walls arranged at intervals and disposed between the first electrode layer and the second electrode layer; wherein a respective first barrier wall of the plurality of first barrier walls is provided between any two adjacent first electrode patterns, and the first barrier wall is located between two electro-dimming patterns corresponding to the two adjacent first electrode patterns.

5. The dimming substrate according to claim 1, wherein a transmittance of the electro-dimming layer to visible light is greater than 40%; and
the dimming substrate further comprises:
a visible light dimming structure stacked with the infrared light dimming structure, the visible light dimming structure being configured to be reversibly switchable between at least a first transparent state and a first color rendering state.

6. The dimming substrate according to claim 5, wherein the visible light dimming structure includes:
a third electrode layer;
a fourth electrode layer disposed opposite to the third electrode layer; and
a first electrochromic layer disposed between the third electrode layer and the fourth electrode layer, the first electrochromic layer being configured to be reversibly switchable between the first transparent state and the first color rendering state in response to a second potential difference applied between the third electrode layer and the fourth electrode.

7. The dimming substrate according to claim 6, wherein
the third electrode layer or the fourth electrode layer includes a plurality of second electrode patterns arranged at intervals; and
the first electrochromic layer includes a plurality of first electrochromic patterns arranged at intervals, and an orthogonal projection of each first electrochromic pattern on a second plane perpendicular to a thickness direction of the visible light dimming structure and an orthogonal projection of a respective one of the plurality of second electrode patterns on the second plane have an overlapping region therebetween;
the visible light dimming structure further includes:
a plurality of second barrier walls arranged at intervals and disposed between the third electrode layer and the fourth electrode layer, wherein a respective second barrier wall of the plurality of second barrier walls is provided between any two adjacent second electrode patterns, and the second barrier wall is located between two first electrochromic patterns corresponding to the two adjacent second electrode patterns.

8. The dimming substrate according to claim 6, wherein the visible light dimming structure further includes:
a second electrochromic layer disposed between the third electrode layer and the fourth electrode layer, the second electrochromic layer being configured to be reversibly switchable between a second transparent state and a second color rendering state in response to the second potential difference.

9. The dimming substrate according to claim 8, wherein the third electrode layer or the fourth electrode layer includes a plurality of second electrode patterns arranged at intervals; and
the second electrochromic layer includes a plurality of second electrochromic patterns arranged at intervals, and an orthogonal projection of each second electrochromic pattern on a second plane perpendicular to a thickness direction of the visible light dimming structure and an orthogonal projection of a respective one of the plurality of second electrode patterns on the second plane have an overlapping region therebetween.

10. The dimming substrate according to claim , wherein the visible light dimming structure further includes:
a second ion transport layer disposed between the third electrode layer and the fourth electrode layer, and stacked with the first electrochromic layer; and
a second ion storage layer disposed between the third electrode layer and the fourth electrode layer, and stacked with the second ion transport layer.

11. A dimming glass, comprising:
a first transparent sheet; and
the dimming substrate according to claim 1, the dimming substrate and the first transparent sheet being stacked.

12. The dimming glass according to claim 11, wherein the dimming substrate further includes a visible light dimming structure stacked with the infrared light dimming structure, and the visible light dimming structure is configured to be reversibly switchable between at least a first transparent state and a first color rendering state.

13. The dimming glass according to claim 11, further comprising a second transparent sheet, wherein
the dimming substrate is located between the first transparent sheet and the second transparent sheet.

14. An apparatus with a viewing window, he apparatus comprising:
an viewing window frame; and
the dimming glass according to claim 11, the dimming glass being installed in the viewing window frame to form the viewing window.

15. A light transmittance adjusting system, comprising:
the dimming substrate according to claim 1; and
a first voltage supply device electrically connected to the first electrode layer and the second electrode layer in the dimming substrate, and configured to apply the first potential difference between the first electrode layer and the second electrode layer. 16. The light transmittance adjusting system according to claim 15, wherein the first voltage supply device is configured to apply the first potential difference in a range of −1.5 V to 0 V inclusive between the first electrode layer and the second electrode layer.

17. The light transmittance adjusting system according to claim 15, wherein the dimming substrate further includes a visible light dimming structure, the visible light dimming structure includes: a third electrode layer, a first electrochromic layer and a fourth electrode layer that are stacked; and the first electrochromic layer is configured to be reversibly switchable between a first transparent state and a first color rendering state ire response to a second potential difference applied between the third electrode layer and the fourth electrode; and
the light transmittance adjusting system further comprises:
a second voltage supply device electrically connected to the third electrode layer and the fourth electrode layer, and configured to apply the second potential difference between the third electrode layer and the fourth electrode layer.

18. The light transmittance adjusting system according to claim 17, wherein the second voltage supply device is configured to apply the second potential difference in a range of 2 V to 4 V inclusive between the third electrode layer and the fourth electrode layer.
